(19) United States
(12) Patent Application Publication
(10) Pub. No.: US 2026/0104627 A1
(43) Pub. Date: Apr. 16, 2026

(54) IMAGING LENS AND IMAGING DEVICE

(71) Applicant: GUANGDONG OPPO MOBILE TELECOMMUNICATIONS CORP., LTD., Dongguan (CN)

(72) Inventor: Tatsuya NAKATSUJI, Nishi-ku (JP)

(21) Appl. No.: 19/404,969

(22) Filed: Dec. 1, 2025

Related U.S. Application Data
(63) Continuation of application No. PCT/CN2023/124324, filed on Oct. 12, 2023.

(51) Int. Cl. G03B 17/17; G03B 30/00

(52) U.S. Cl. CPC G03B 17/17; G03B 30/00

(57) ABSTRACT

The present application provides an imaging lens and an imaging device. The imaging lens includes, in order of passage of light from an object side, a diaphragm; a lens group including at least one lens having positive optical power and at least one lens having negative optical power; and a reflective light guide element configured to emit light toward an imaging element. The one lens having positive optical power is made of glass material, and the reflective light guide element has reflecting surfaces on which an optical path is reflected multiple times.

### CROSS REFERENCE TO RELATED APPLICATIONS

The present disclosure is a continuation of International Patent Application No. PCT/CN2023/124324, filed Oct. 12, 2023, the entire disclosure of which is incorporated herein by reference.

### TECHNICAL FIELD

The present disclosure relates to an imaging lens and an imaging device.

### BACKGROUND ART

Conventionally, a wide-angle single focus lens mounted on a smartphone extends the entire lens in a thickness direction of a body of the smartphone to perform a focus. A method of moving the lens in the thickness direction of the body of the smartphone is advantageous for thinning the body of the smartphone. A telephoto lens with a small sensor dimension performs the focus by extending the entire lens in the thickness direction of the body of the smartphone, similar to the wide-angle single focus. However, because a focal length becomes longer and a movement distance of the lens during focusing becomes longer when trying to mount a telephoto lens with a large sensor dimension, it is difficult to mount an optical system that moves the lens in the thickness direction of the body of the smartphone. For that reason, the telephoto lens with a large sensor dimension generally employs a periscope method. However, because the periscope method determines the thickness of the body of the smartphone in the thickness direction by the size of the short side of the sensor or the F-number of the lens, a telephoto lens with a large sensor dimension and a small F-number is disadvantageous for thinning the body of the smartphone.

Moreover, when trying to reduce the thickness of the body of the smartphone with the periscope method, the lens may use a lens obtained by partly cutting the shape of the lens from a circular shape. However, in this case, because the molding manufacturing of the plastic lens and the eccentricity adjustment by the lens rotation when installing the lens are impossible, a yield ratio of the lens is deteriorated.

### SUMMARY

An imaging lens according to one aspect of the present disclosure includes, in order of passage of light from an object side, a diaphragm; a lens group including at least one lens having positive optical power and at least one lens having negative optical power; and a reflective light guide element configured to emit light toward an imaging element. The one lens having positive optical power is made of glass material, and the reflective light guide element has reflecting surfaces on which an optical path is reflected multiple times.

An imaging device according to another aspect of the present disclosure includes the imaging lens described above and an imaging element configured to capture an image of an object via the imaging lens.

### BRIEF DESCRIPTION OF DRAWINGS

FIG. 1 is a diagram illustrating an example of a configuration of an imaging lens of which all lenses of a lens group are configured of plastic lenses.

FIG. 2A is a diagram illustrating Diffraction MTF with an infinite (INF) shooting distance in the imaging lens in FIG. 1 of which all the lenses of the lens group are configured of plastic lenses.

FIG. 2B is a diagram illustrating Diffraction MTF with a shooting distance of 1 m in the imaging lens in FIG. 1 of which all the lenses of the lens group are configured of plastic lenses.

FIG. 3A is a diagram illustrating Diffraction MTF for the temperature of 25° C. in the imaging lens in FIG. 1.

FIG. 3B is a diagram illustrating Diffraction MTF for the temperature of 60° C. in the imaging lens in FIG. 1.

FIG. 4 is an explanatory diagram illustrating an imaging lens according to a first embodiment.

FIG. 5 is an explanatory diagram illustrating parameters of the imaging lens according to the first embodiment.

FIG. 6A is a diagram illustrating an example of Diffraction MTF (shooting distance: INF) when using a glass spherical lens at a temperature of −40° C.

FIG. 6B is a diagram illustrating an example of Diffraction MTF (shooting distance: INF) when using the glass spherical lens at a temperature of 22° C.

FIG. 6C is a diagram illustrating an example of Diffraction MTF (shooting distance: INF) when using the glass spherical lens at a temperature of 65° C.

FIG. 7 is a diagram illustrating an example of a configuration of the imaging lens according to Example 1.

FIG. 8 is a diagram illustrating Diffraction MTF (temperature of 20° C.) of the imaging lens according to Example 1.

FIG. 9 is a diagram illustrating optical paths at the temperature of 65° C. in the imaging lens illustrated in FIG. 7.

FIG. 10 is a diagram illustrating Diffraction MTF (temperature of 65° C.) of the imaging lens according to Example 1.

FIG. 11A is an aberration diagram illustrating an astigmatism at the temperature of 20° C. in the imaging lens according to Example 1.

FIG. 11B is an aberration diagram illustrating a spherical aberration at the temperature of 20° C. in the imaging lens according to Example 1.

FIG. 11C is an aberration diagram illustrating a distortion aberration at the temperature of 20° C. in the imaging lens according to Example 1.

FIG. 11D is an aberration diagram illustrating a chromatic aberration at the temperature of 20° C. in magnification of the imaging lens according to Example 1.

FIG. 12 is a diagram illustrating an example of a configuration of the imaging lens according to Example 2.

FIG. 13A is an aberration diagram illustrating an astigmatism of the imaging lens according to Example 2.

FIG. 13B is an aberration diagram illustrating a spherical aberration of the imaging lens according to Example 2.

FIG. 13C is an aberration diagram illustrating a distortion aberration of the imaging lens according to Example 2.

FIG. 13D is an aberration diagram illustrating a chromatic aberration of magnification of the imaging lens according to Example 2.

FIG. 14 is a diagram illustrating an example of a configuration of the imaging lens according to Example 3.

FIG. 15A is an aberration diagram illustrating an astigmatism of the imaging lens according to Example 3.

FIG. 15B is an aberration diagram illustrating a spherical aberration of the imaging lens according to Example 3.

FIG. 15C is an aberration diagram illustrating a distortion aberration of the imaging lens according to Example 3.

FIG. 15D is an aberration diagram illustrating a chromatic aberration of magnification of the imaging lens according to Example 3.

FIG. 16 is an explanatory diagram illustrating the imaging lens according to a first modification example of the first embodiment.

FIG. 17 is a diagram illustrating an example of a configuration of the imaging lens according to Example 4.

FIG. 18A is an aberration diagram illustrating an astigmatism of the imaging lens according to Example 4.

FIG. 18B is an aberration diagram illustrating a spherical aberration of the imaging lens according to Example 4.

FIG. 18C is an aberration diagram illustrating a distortion aberration of the imaging lens according to Example 4.

FIG. 18D is an aberration diagram illustrating a chromatic aberration of magnification of the imaging lens according to Example 4.

FIG. 19 is an explanatory diagram illustrating the imaging lens according to a second modification example of the first embodiment.

FIG. 20 is a diagram illustrating an example of a configuration of the imaging lens according to Example 5.

FIG. 21A is an aberration diagram illustrating an astigmatism of the imaging lens according to Example 5.

FIG. 21B is an aberration diagram illustrating a spherical aberration of the imaging lens according to Example 5.

FIG. 21C is an aberration diagram illustrating a distortion aberration of the imaging lens according to Example 5.

FIG. 21D is an aberration diagram illustrating a chromatic aberration of magnification of the imaging lens according to Example 5.

FIG. 22 is a diagram illustrating an example of a configuration of an imaging device according to a second embodiment.

FIG. 23 is a diagram illustrating an example of a configuration of a camera of a camera part.

FIG. 24 is a diagram illustrating a mounting example of an imaging lens with temperature compensation illustrated in FIG. 4.

FIG. 25 is a diagram illustrating an example of a configuration of a smartphone mounted with a periscope lens.

FIG. 26 is a diagram explaining a difference in thickness between a periscope smartphone and a smartphone illustrated in FIGS. 22, 23, and 24.

### DETAILED DESCRIPTION

Hereinafter, an imaging lens and an imaging device according to embodiments will be described in detail with reference to the accompanying drawings. Note that the present invention is not limited to the embodiments.

An imaging lens of the present suggestion will be described below the following “Imaging Lens with Temperature Compensation”. Before explaining the imaging lens with the temperature compensation of the present suggestion, an imaging lens without the temperature compensation will be first described as an example of an imaging lens of which all lenses of a lens group are configured of plastic lenses. Then, an imaging lens with the temperature compensation will be described according to a first embodiment and first and second modification examples of the first embodiment, and these examples are illustrated in Examples 1 to 5. Moreover, an imaging device will be described according to a second embodiment.

Furthermore, the lens has temperature dependence, and thus a position where an object is in focus changes depending on temperature. In the case of a telephoto lens in a method of extending the lens, some of movable distances of the lens are replaced by movement distances for the focus correction by temperature when focusing up to the shortest shooting distance. In the smartphone etc., when the movement distance of the lens in the thickness direction of the body is limited, a movement distance that can be used to focus on the shortest shooting distance is shortened if a proportion of movement distances for the focus correction by the temperature is increased. For this reason, the shortest shooting distance is not shortened if there is a temperature effect.

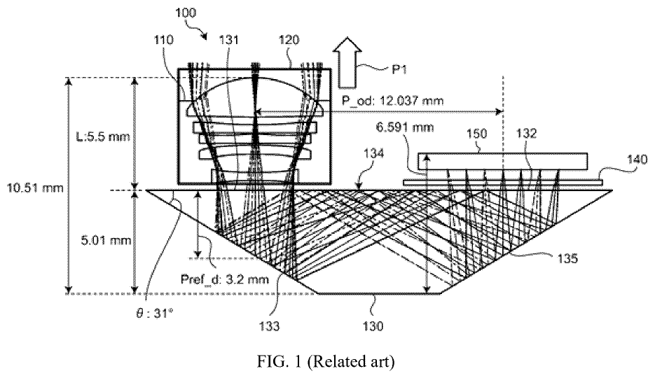

FIG. 1 is a diagram illustrating an example of a configuration of an imaging lens 100 of which all lenses of a lens group are configured of plastic lenses. FIG. 1 illustrates the imaging lens 100 having a telephoto lens configuration, with a 35 mm equivalent focal length of 129 mm that is equivalent to the size of a full-frame sensor, as an example. An imaging element 150 that is used herein is an image sensor having the size of ½ inch. In the imaging lens 100 illustrated in FIG. 1, optical paths indicate, among incident rays of light that are incident on a lens group 120 from an object side, an optical path of a ray passing through an optical axis, an optical path of a ray passing through an upper side of lens of the lens group 120, and an optical path of a ray passing through a lower side of lens of the lens group 120.

The imaging lens 100 includes a diaphragm 110, the lens group 120, and a reflective light guide element 130. The light from the object side passes through the diaphragm 110, the lens group 120, and the reflective light guide element 130 in this order.

The reflective light guide element 130 guides the rays incident from an incident surface 131 of the reflective light guide element 130 to an exit surface 132 of the reflective light guide element 130. A portion of the contour of the reflective light guide element 130 has a configuration that the incident rays are reflected thereinside.

The reflective light guide element 130 is designed to reflect rays by multiple times, and illustrates a prism to be designed to reflect the rays three times, as an example. The reflective light guide element 130 reflects the incident rays on a first slope 133, a first plane 134, and a second slope 135 of the reflective light guide element 130 in this order. In the reflective light guide element 130 illustrated as an example, the incident surface 131, the first plane 134, and the exit surface 132 are on the same surface. The positions of the incident surface 131, the first plane 134, and the exit surface 132 on the same surface are different from one another.

The rays reflected by the second slope 135 are emitted from the exit surface 132 of the reflective light guide element 130. The rays emitted from the exit surface 132 of the reflective light guide element 130 form an image on a sensor surface of the imaging element 150 via an IR filter 140.

The imaging element 150 photo-electrically converts the light from the object by using a plurality of pixels arranged in a two-dimensional array and outputs pixel signals. The imaging element 150 is an image sensor such as CCD (Charge Coupled Device) and CMOS (Complementary Metal Oxide Semiconductor), as an example.

The lens group 120 of the imaging lens 100 has a configuration that the lens group is driven by a driving means to mechanically extend it in a direction P1 that is a thickness direction of a body of an imaging device. With this configuration, the performance has been checked like the following. Note that the imaging lens 100 will be described below as an imaging lens of a smartphone but it is only an example and one mounted with the imaging lens is not limited to the smartphone. If the one is an imaging device mounted with an imaging lens, the imaging lens 100 to be described below may be applied to this imaging device as appropriate. For example, the imaging lens 100 may be applied to a tablet terminal etc.

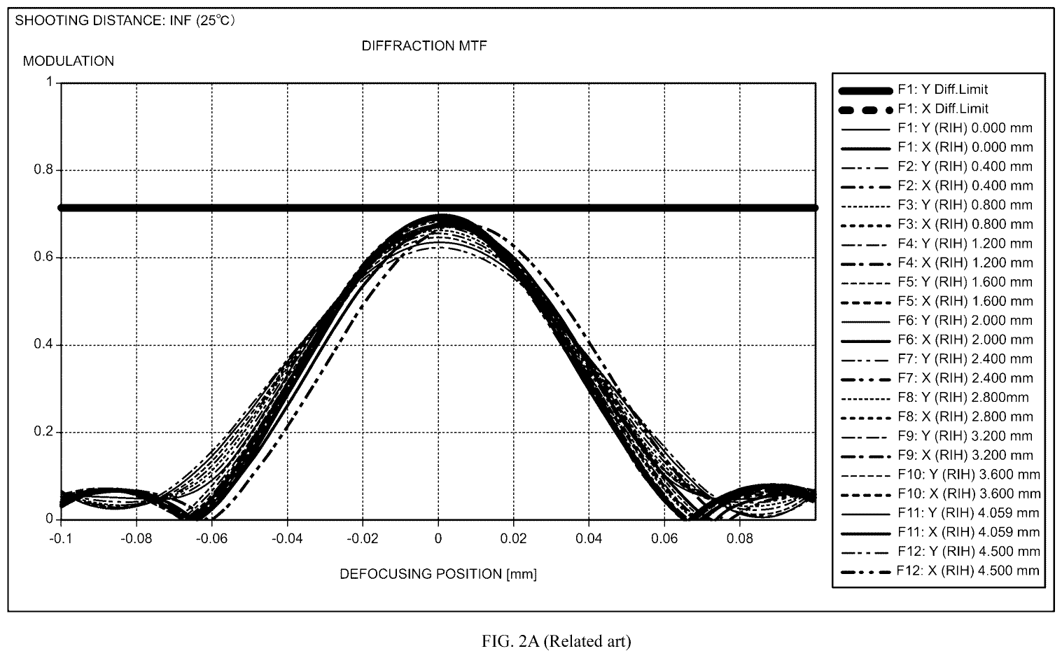

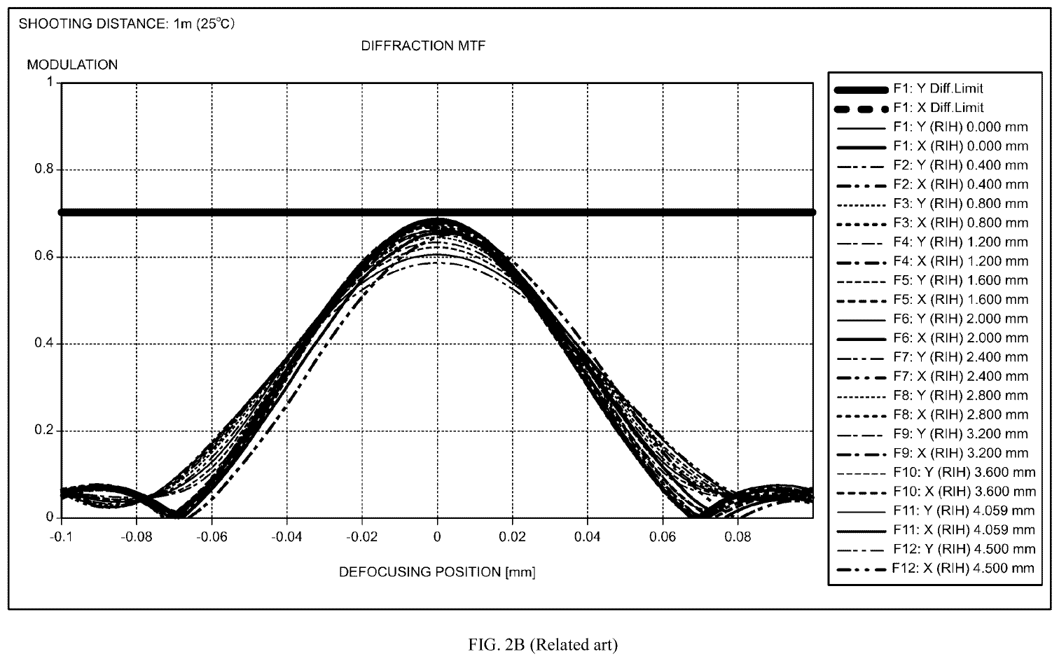

FIGS. 2A and 2B are diagrams illustrating an example of Diffraction MTF (Modulation Transfer Function) in the imaging lens in FIG. 1 of which all the lenses of the lens group 120 are configured of plastic lenses. FIG. 2A illustrates a case where a shooting distance is infinite (INF) and FIG. 2B illustrates a case where the shooting distance is 1 m. A shooting distance means a distance between the object and the lens surface closest to the object. Each drawing illustrates a characteristic curve every image height (mm) in rays of a sensor short-side direction (Y) and a sensor long-side direction (X) by using the horizontal axis as an axis indicating defocusing positions in a sensor optical axis direction.

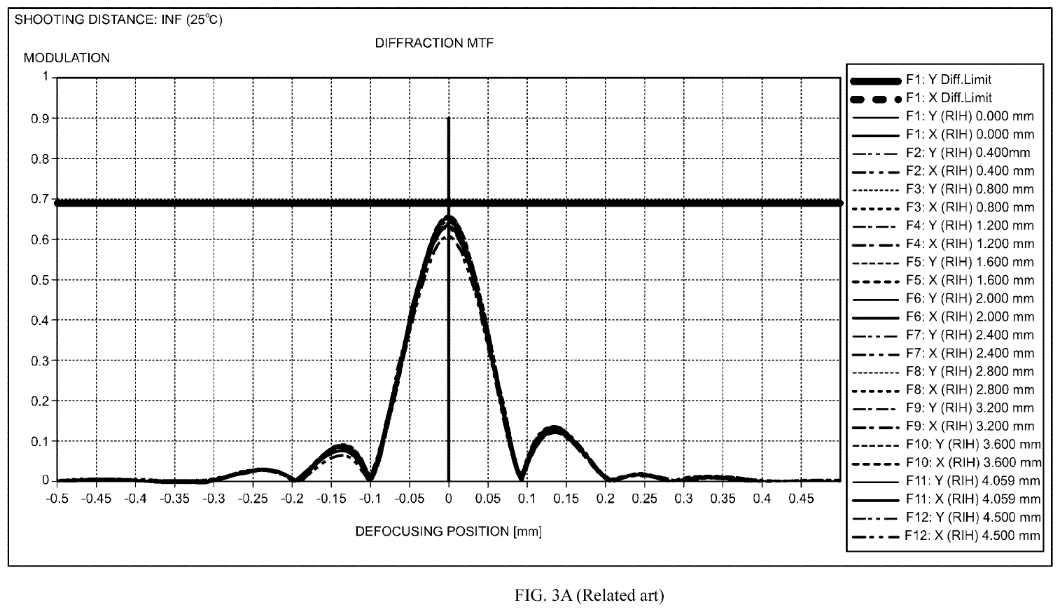

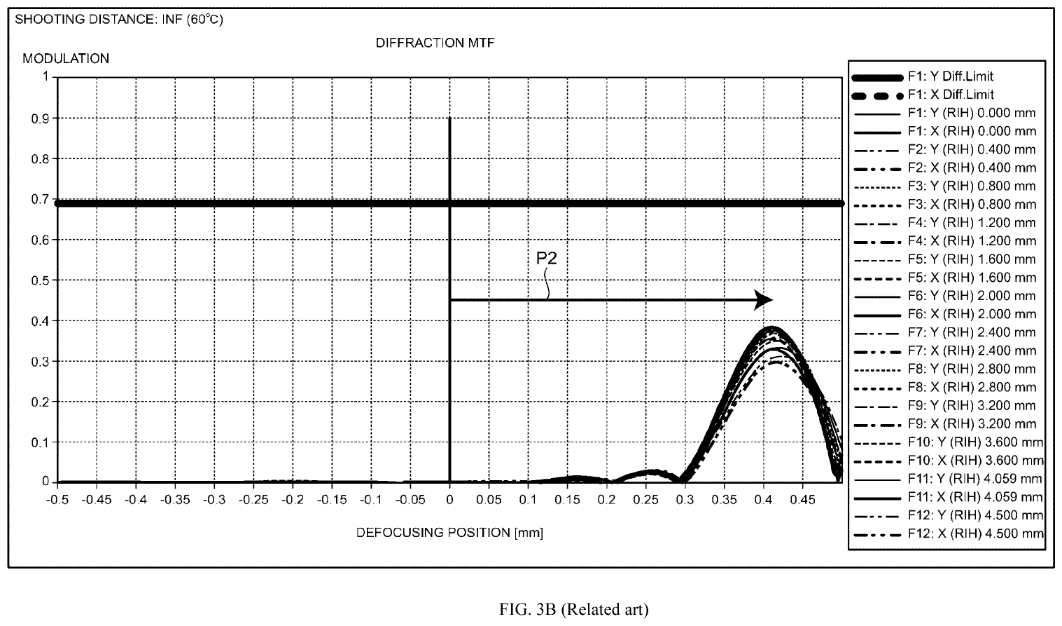

FIGS. 3A and 3B are diagrams illustrating an example of Diffraction MTF when temperature is changed in the lens illustrated FIG. 1. FIG. 3A is an example of a general use range when the temperature is 25° C., and FIG. 3B is an example when the temperature is raised to 60° C.

At the temperature of 60° C. compared to the temperature of 25° C., a linear expansion coefficient, a curvature, etc. of a plastic lens are changed, and thus a focal length is changed and a focus is deviated from the sensor surface. In the example illustrated in FIGS. 3A and 3B, by temperature rise, a peak shifts from a line of the reference 0 mm to a positive direction that is an arrow P2 direction. Therefore, a defocus occurs from the sensor surface to the positive direction that is the thickness direction of the imaging element 150, and when simulation is performed in the lens with the configuration of FIG. 1, the in-focus position is consequently deviated about 0.4 mm only by temperature rise from 25° C. to 60° C.

In the imaging lens 100 illustrated in FIG. 1, the shortest shooting distance is about 1.1 m when the movement of the lens is 0.55 mm, and the shortest shooting distance is about 1 m when the movement of the lens is 0.608 mm. Because a driving means such as VCM (voice coil motor) adapted to the thickness of the smartphone can take out only a movement distance of about 0.5 to 0.6 mm, about 0.4 mm of the movement distance is used for the correction of position deviation due to temperature. In this case, the remaining movement distance is about 0.1 to 0.2 mm and the shortest shooting distance is about 3 m at the movement distance of 0.2 mm, and thus it turns out that the shortest shooting distance does not become small if the lens is not an imaging lens with temperature compensation.

Moreover, it can be also considered that the VCM is added in the thickness direction P1 of the body of the smartphone to extend a movement distance, but this is not employed due to large size. Because the addition of the VCM is employed for the periscope type, there is no particular advantage in adding the VCM in the thickness direction P1 of the body in the case of the thin body.

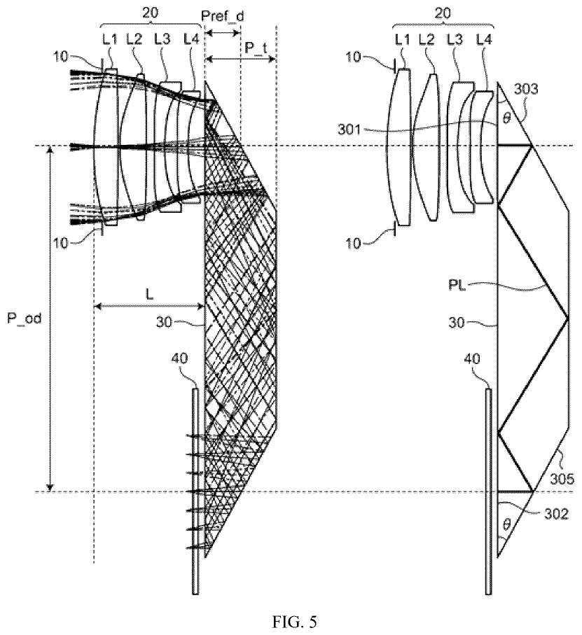

Note that parameters of the imaging lens 100 from which the simulation results as above are obtained are illustrated in FIG. 1 and Table 1 as an example. The viewpoints of these parameters are collectively explained in the description of parameters in FIG. 5 on the imaging lens with temperature compensation to be described later.

TABLE 1

| | |
|---|---|
| FOCAL LENGTH | 24.26 |
| SENSOR | 4.059 |
| DIMENSION | |
| FNO | 4 |
| L | 5.5 |
| PRISM REFRACTIVE | 1.5168 |
| INDEX | |
| θ | 31° |
| Pref_d | 3.2 mm |
| P_od | 12.037 mm |

The present disclosure has been made in view of the above-described problem, and an aim of the present disclosure is to provide an imaging lens and an imaging device, which can thin a body of the imaging device and can shorten the shortest shooting distance.

Imaging Lens with Temperature Compensation

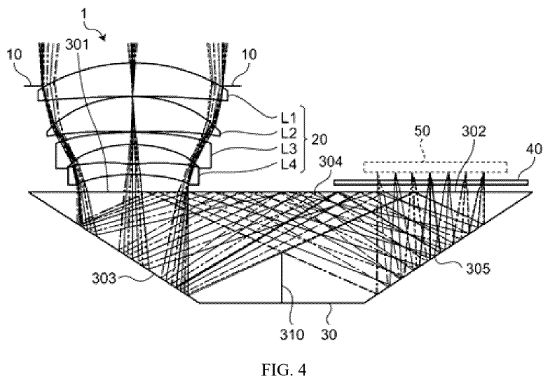

From now, a configuration of an imaging lens with temperature compensation will be described. FIG. 4 is an explanatory diagram illustrating an imaging lens 1 according to a first embodiment. The configuration of the imaging lens 1 illustrated in FIG. 4 is an example of the configuration explaining an imaging lens with the temperature compensation. First, the configuration of the imaging lens with the temperature compensation will be totally described by using the imaging lens 1 illustrated in FIG. 4. Moreover, parameters of the imaging lens with the temperature compensation will be described with reference to FIG. 5.

FIG. 5 is an explanatory diagram illustrating parameters of the imaging lens according to the first embodiment. The imaging lens illustrated in FIG. 5 corresponds to a drawing obtained by rotating the imaging lens 1 in FIG. 4 viewed from the right surface by 90° to the right and then viewing it from the left surface by multiple reflections. The imaging lens illustrated in FIG. 5 has the same reference numbers as those of FIG. 4 to understand a correspondence relationship with the imaging lens 1 illustrated in FIG. 4.

The imaging lens 1 illustrated in FIG. 4 includes a diaphragm 10, a lens group 20, and a reflective light guide element 30. The light from the object side passes through the diaphragm 10, the lens group 20, and the reflective light guide element 30 in this order. The light passing through the reflective light guide element 30 emits toward an IR filter 40. Note that the imaging lens 1 may have a configuration including not only a lens configuration but also another optical element. For example, the imaging lens may have a configuration including a color correction member such as the IR filter 40 in FIG. 4 and another optical element.

The IR filter 40 in FIG. 4 is an example of the color correction member, and performs infrared absorption. The color correction member may be changed to a member that performs the other color correction as appropriate, without being limited to infrared absorption.

Note that optical paths illustrated in the imaging lens 1 illustrated in FIG. 4 indicate, among incident rays of light that are incident on the lens group 20 from the object side, an optical path of a ray passing through the optical axis, an optical path of a ray passing through the upper side of lens of the lens group 20, and an optical path of a ray passing through the lower side of lens of the lens group 20. Unless otherwise specified, optical paths of the imaging lens illustrated in other drawings are the same as those of FIG. 4.

### Configuration of Lens Group

The lens group 20 illustrated in FIG. 4 as an example is a lens group of four pieces per group. The lens group 20 includes, in order from the object side, a first lens, a second lens, a third lens, and a fourth lens. The first lens to the fourth lens are together arranged on the optical axis. Herein, the first lens corresponds to “a first lens through which the light from the object side passes first”, and the fourth lens corresponds to “a final lens through which the light from the object side passes finally” because the lens group 20 illustrated in FIG. 4 has four pieces per group. Hereinafter, the first lens, the second lens, the third lens, the fourth lens, etc. are respectively referred to as a first lens L1, a second lens L2, a third lens L3, a fourth lens L4, etc., and are respectively indicated by the reference numbers of L1, L2, L3, L4, etc. in drawings and tables.

The number of lenses of the lens group 20 is an example, and the number is not limited to four pieces. For example, the lens group may have a five-piece configuration, a six-piece configuration, or the like. In the case of the five-piece configuration, “the final lens” is the fifth lens L5, and in the case of the six-piece configuration, “the final lens” is the sixth lens L6.

Moreover, the lens group 20 includes at least one lens having positive optical power and at least one lens having negative optical power. The lens group 20 illustrated in FIG. 4 as an example includes the first lens L1 and the second lens L2 having positive optical power, and the third lens L3 and the fourth lens L4 having negative optical power.

One of the lenses having positive optical power is made of glass material for the sake of temperature compensation. In the lens configuration of the lens group 20 illustrated as an example, the first lens L1 uses a lens of glass material for the sake of temperature compensation. The other lenses are plastic lenses. Because weight gets heavy and it becomes expensive when produced with aspherical surface if the lenses including one lens having positive optical power and the other lenses are made of glass material, the other lenses use plastic lenses. Therefore, when the second lens L2 is made of glass material, it is desirable that the first lens L1 is a plastic lens.

### Configuration of Reflective Light Guide Element

The reflective light guide element 30 illustrated in FIG. 4 as an example is a prism with three-time reflection design. A first slope 303, a first plane 304, and a second slope 305 are provided to have angles by which incident rays are totally reflected. The reflective light guide element 30 reflects rays incident from the incident surface 301 on the first slope 303, the first plane 304, and the second slope 305 in this order. The first slope 303, the first plane 304, and the second slope 305 are an example of “reflecting surfaces”. Depending on the number of reflections, the reflective light guide element 30 includes a second plane facing the first plane 304 as “the reflecting surfaces”.

In the reflective light guide element 30 illustrated as an example, the incident surface 301, the first plane 304, and the exit surface 302 are on the same surface. The positions of the incident surface 301, the first plane 304, and the exit surface 302 on the same surface are different from one another.

The rays reflected by the second slope 305 are emitted from the exit surface 302 of the reflective light guide element 30. The rays emitted from the exit surface 302 of the reflective light guide element 30 form an image on the sensor surface of the imaging element 50 via the IR filter 40.

Note that, when there is one that does not have an angle satisfying the total reflection among “the reflecting surfaces” such as the first slope 303, the first plane 304, and the second slope 305, reflective material may be applied on its surface etc. to reflect the rays. For example, metal coating such as metal enhanced reflection film is performed by metal vapor deposition.

Moreover, to reduce or cut the reflection of unnecessary rays inside the reflective light guide element 30, a low-reflection black absorber may be provided on a portion of the surface of the reflective light guide element 30. For example, a low-reflection black absorption film is formed by sputtering on the portion of the surface of the reflective light guide element 30.

Moreover, among passage paths of the rays from the incident surface 301 to the exit surface 302 of the reflective light guide element 30, a ray cut part 310 may be provided in a portion other than regular optical paths of the rays to cut unnecessary rays. For example, the ray cut part 310 is arranged as a light shielding part of a light shielding ink layer inside the reflective light guide element 30 by partially dividing the reflective light guide element 30, applying light shielding ink, and then again bonding the divided portions.

Instead of the light shielding part, a void part may be provided by notching a portion of the reflective light guide element 30 from the front surface toward the inside or hollowing out the portion as the ray cut part 310 to cut unnecessary rays.

Moreover, the reflective light guide element may have a configuration that a dichroic reflecting mirror is provided on “the reflecting surface” such as the first slope 303 to remove or reduce rays other than effective rays by changing a reflectance in response to an incident angle of rays.

In the example of the imaging lens 1 illustrated in FIG. 4, because the exit surface 302 of the reflective light guide element 30 is located in the same plane as the incident surface 301 of the reflective light guide element 30, the IR filter 40 and the imaging element 50 are together arranged to face the same plane as the incident surface 301. The imaging element 50 is an image sensor such as CCD and CMOS.

### Explanation for Parameters

Next, various parameters will be described with reference to FIG. 5. FIG. 5 illustrates parameters corresponding to the configuration of multiple reflections.

“P_od” is a parameter indicating a distance between the optical axis of the incident rays to the lens group 20 and the optical axis of the emitted rays from the reflective light guide element 30 to the imaging element 50. A unit of P_od is a millimeter (mm). “L” is a parameter indicating a distance from the lens vertex of the first lens L1 to the reflective light guide element 30. “Pref_d” is a parameter indicating a distance from the incident surface 301 of the reflective light guide element 30 to an intersection point at which the lens optical axis and the first reflecting surface (the first slope 303) intersect with each other. Herein, the lens optical axis is an optical axis of the lens center of the lens group 20. A unit of Pref_d is a millimeter (mm). “P_t” is a parameter indicating the thickness of the reflective light guide element 30 in the lens optical axis direction. A unit of P_t is a millimeter (mm). “θ” is a parameter indicating an angle between the incident surface 301 of the reflective light guide element 30 and the slope surface of the first slope 303. In the example illustrated in FIG. 5, an angle between the exit surface 302 of the reflective light guide element 30 and the slope surface (in this example, the fifth reflecting surface) of the second slope 305 is also the same value as θ. A unit of θ is deg (degree). “PL” is an optical length of an optical path by which the lens optical axis rays pass through the reflective light guide element 30. In FIG. 5, PL is an optical length inside the reflective light guide element 30.

### Simulation of Suppression of Defocus by Temperature Compensation

With the lens configuration illustrated in FIG. 4, the inventor of this application adjusts power with the first lens L1 as a glass spherical lens and optically designs the imaging lens 1 to satisfy the setting of Table 2 to be described later in order to perform a simulation.

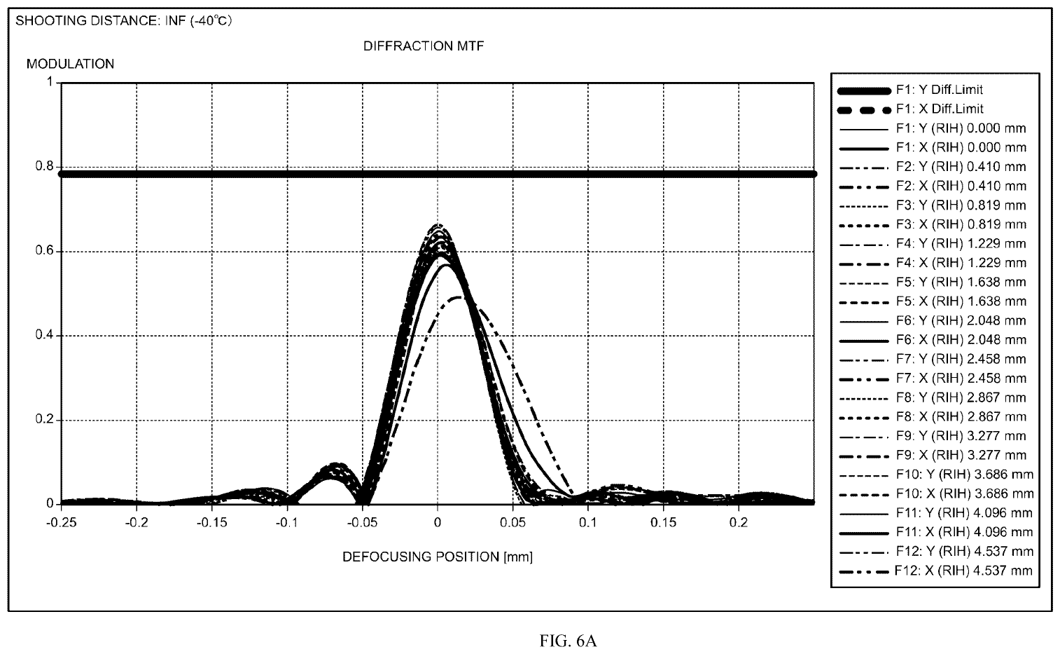

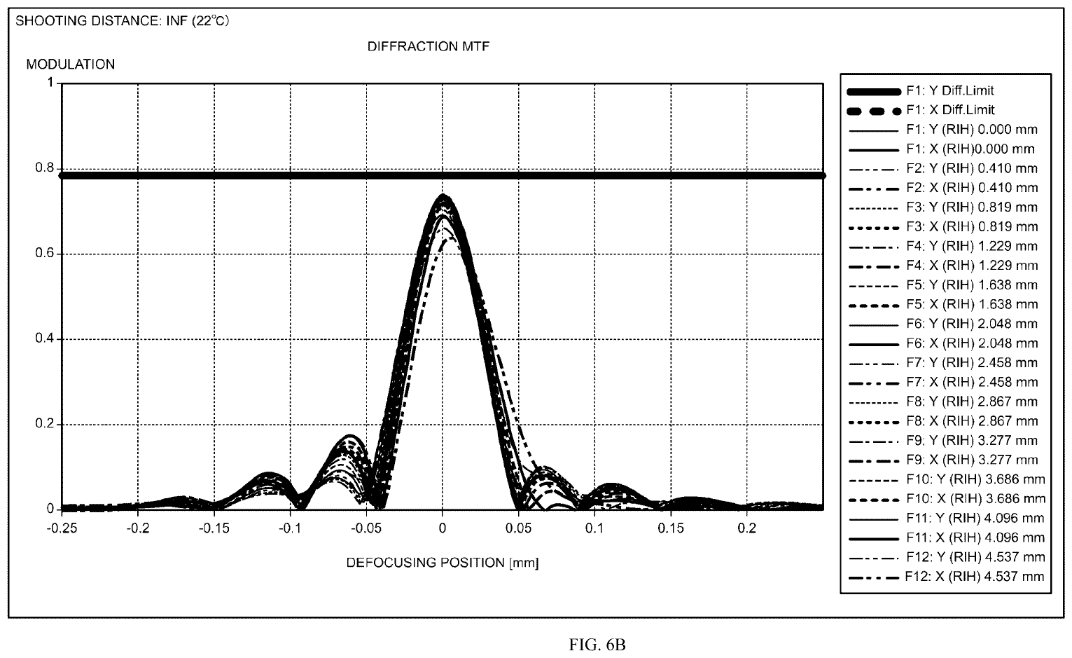

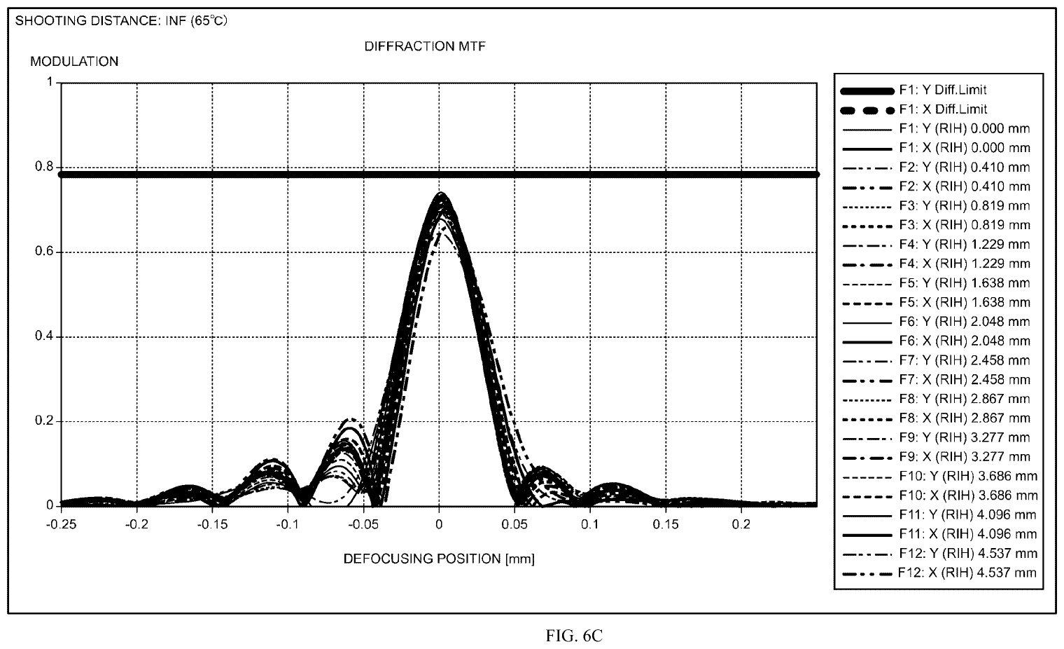

FIGS. 6A, 6B, and 6C are diagrams illustrating an example of Diffraction MTF (shooting distance: INF) when using the glass spherical lens. FIG. 6A is an example for the temperature of −40° C., FIG. 6B is an example for the temperature of 22° C., and FIG. 6C is an example for the temperature of 65° C.

As illustrated in FIGS. 6A, 6B, and 6C, a peak is the position of substantially 0 mm on the axis indicating a defocusing position in the sensor optical axis direction even at any temperature, and thus it turns out that the defocus due to temperature does not substantially occur.

TABLE 2

| | |
|---|---|
| FOCAL LENGTH | 24.79 |
| SENSOR | 4.096 |
| DIMENSION | |
| FNO | 2.979 |
| L | 5.99 |
| PRISM REFRACTIVE | 1.5168 |
| INDEX | |
| θ | 33° |
| Pref_d | 3.05 mm |
| P_od | 13.701 mm |

The focal length illustrated in Table 2 is a focal length (EFL) of the entire lens. In the focal length illustrated in Table 4 to be described later, the EFL corresponds to the focal length of the first lens L1 to the fourth lens L4. The sensor dimension (dd) is the half size of the sensor surface in a diagonal direction. The FNO is F-number. The prism refractive index is the refractive index Nd of the reflective light guide element 30.

TABLE 3
FOCUS POSITION CHANGE AMOUNT
BY TEMPERATURE CHANGE

| TEMP. | AFFL |
|---|---|
| −40 | −0.010 |
| −25 | −0.008 |
| −10 | −0.005 |
| 5 | −0.003 |
| 20 | 0 |
| 35 | 0.001 |
| 50 | 0.002 |
| 65 | 0.004 |

In further detail, Table 3 illustrates values of defocus due to temperature in a range from −40° C. to 65° C. indicated by “TEMP (temperature)” with the lens configuration illustrated in FIG. 4. “ΔFFL” indicates positive and negative position deviation (unit mm) every temperature from the reference of 0 mm with the temperature of 20° C. as the reference of 0 mm. “ΔFFL” indicates a variation of the focus distance of the lens, and a variation of the focus position becomes small if this change is small. It turns out that a variation of the focus due to temperature change is extremely small from Table 3.

Note that the deviation of the focus position may swing to the minus side beyond 0 mm from the plus side if the correction of the position deviation by the temperature compensation is made too strong. Therefore, in such a case, adjustment is performed into a desired range as appropriate to fall within around 0 mm. Note that a conditional expression for this is Condition 1 to be described later.

According to the simulation of the imaging lens 1 illustrated in FIG. 4, the focus variation in a range from −40° C. to 65° C. is 0.014 mm and the defocus due to temperature is substantially eliminated. For this reason, in the imaging lens with the temperature compensation, most of movable distances of the lens can be used to focus to the shortest shooting distance. Moreover, because it is possible to move the lens in the thickness direction of the body of the smartphone by using the reflective light guide element 30 with multiple reflections, the shortest shooting distance can be shortened when using a telephoto lens and it is suitable for thinning the body of the smartphone.

### Optical Setting Conditions

The inventor performs optical simulation with various settings in the imaging lens with the temperature compensation, and obtains optical setting conditions particularly effective in suppressing the defocus due to temperature.

$$1 / Focal length of glass material lens < 0.06 \qquad ( Condition 1 )$$

$$0.7 < Focal length of glass material lens / EFL < 1. \qquad ( Condition 2 )$$

$$- 1. < EPT / PL < - 0.7 \qquad ( Condition 3 )$$

$$3 < EFL / dd \qquad ( Condition 4 )$$

$$EPD / Pref\_d < 3.5 \qquad ( Condition 5 )$$

$$f\_F > 0 \qquad ( Condition 6 )$$

$$f\_B2 < 0 \qquad ( Condition 7 )$$

$$- 1.5 < f\_B2 / f\_F < - 0.5 \qquad ( Condition 8 )$$

$$L > P\_t \qquad ( Condition 9 )$$

$$- 10 < f\_B / Focal length of glass material lens < - 1 \qquad ( Condition 10 )$$

Herein, “EPT” means an exit pupil distance of the imaging lens 1. “EPD” means an exit pupil diameter. “f_B2” means a focal length (composite focal length) of the rear two lenses. The “rear two lenses” indicate, among the lenses included in the lens group 20 of the imaging lens 1, two lenses of a lens through which the light from the object side passes finally and a lens just before the final lens. “f_F” means a focal length (composite focal length) of the front lenses other than the rear two lenses. The “front lenses other than the rear two lenses” indicate, among the lenses included in the lens group 20 of the imaging lens 1, the remaining lenses other than the rear two lenses. When the lens group 20 has a four-piece configuration like the imaging lens 1 as an example, “f_F” indicates the focal length (composite focal length) of the front two lenses. When the lens group 20 has a five-piece configuration, “f_F” indicates the focal length (composite focal length) of the front three lenses. When the lens group 20 has a six-piece configuration, “f_F” indicates the focal length (composite focal length) of the front four lenses. “f_B” indicates a focal length (composite focal length) of plastic lenses other than glass material.

Condition 1 is a condition to prevent a correction amount in a temperature change from becoming too strong.

Condition 2 is a condition to appropriately adjust power of a glass material lens with reference to the entire power.

Condition 3 is a condition to appropriately set the prism optical length PL.

Condition 4 is a condition to accomplish three or more reflections with the reflective light guide element 30 of a telephoto lens system.

Condition 5 is a condition to appropriately set the optical length.

Condition 6 is a condition that the front lenses other than the rear two lenses have positive optical power.

Condition 7 is a condition that the rear two lenses have negative optical power.

Condition 8 is a condition to constrain a ratio of the focal length. In this range, three reflections or five reflections can be made by extending the back.

Condition 9 is a condition to have the thickness of the reflective light guide element 30 thinner than the thickness of the lens group 20 in the lens optical axis direction.

Condition 10 is a condition to cause the glass material lens to have power because a temperature change in the plastic lens is large.

These conditions may be individually implemented or may be implemented in any combination. Examples satisfying at least one of these conditions are illustrated below. Note that, hereinafter, common components such as the diaphragm 10, the lens group 20, the reflective light guide element 30, and the IR filter 40 of the imaging lens 1 illustrated in FIG. 4 are respectively indicated by the same names such as a diaphragm, a lens group, a reflective light guide element, and an IR filter, and have the changed reference numbers. The details of each optical setting are referred to by data to be referred every Example.

### Example 1

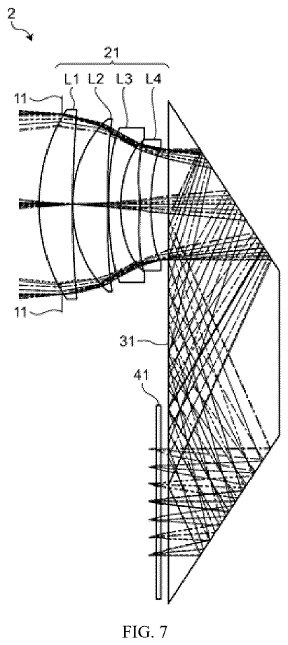

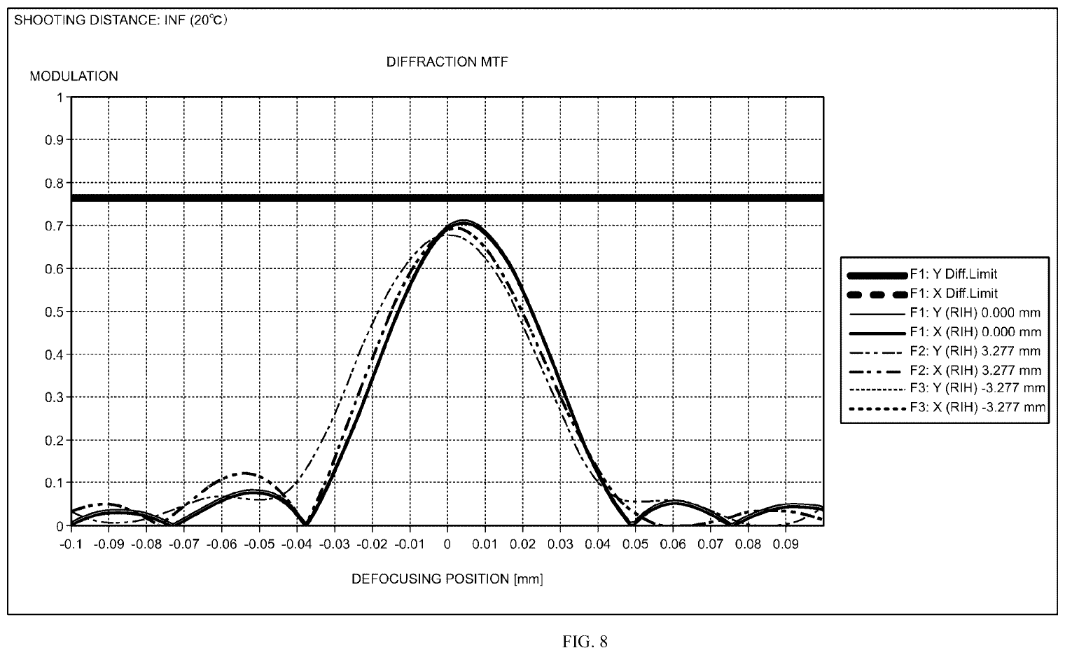

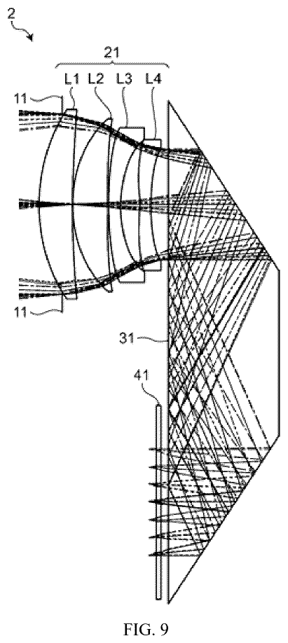

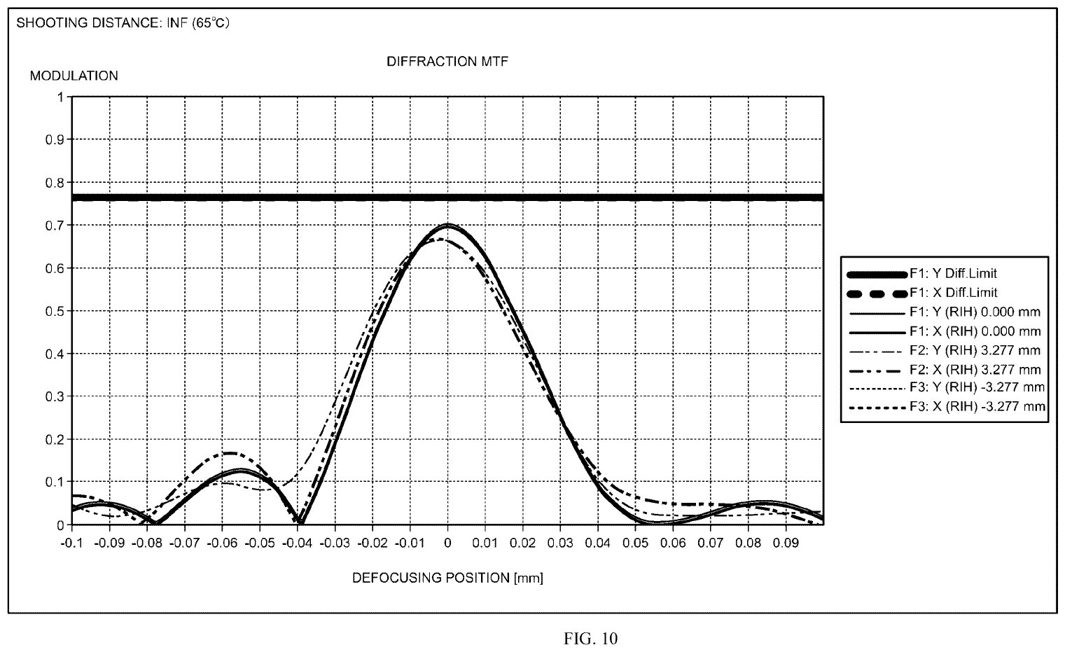

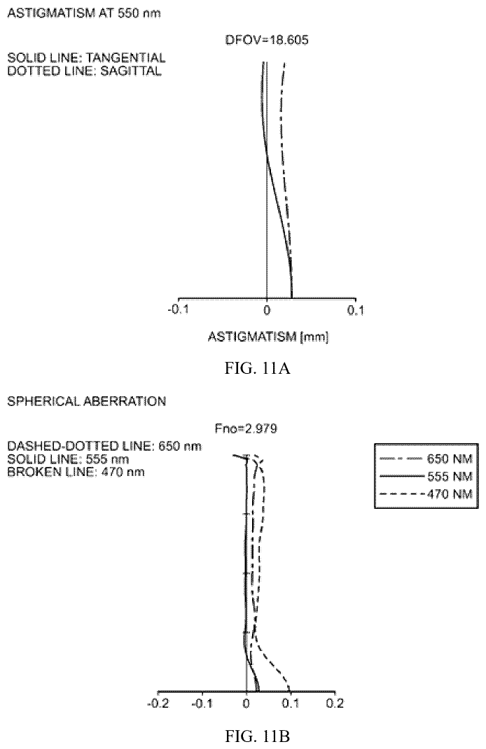

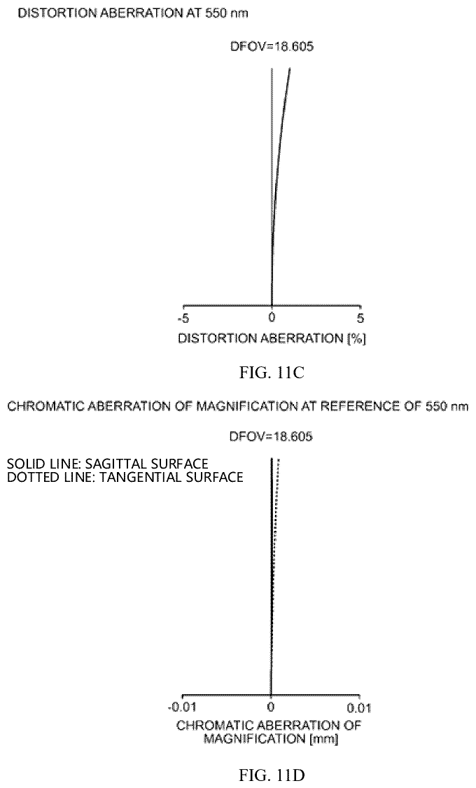

FIG. 7 is a diagram illustrating an example of a configuration of an imaging lens 2 according to Example 1. The imaging lens 2 illustrated in FIG. 7 includes a diaphragm 11, a lens group 21, and a reflective light guide element 31. The light from the object side passes through the diaphragm 11, the lens group 21, and the reflective light guide element 31 in this order, and is emitted toward an IR filter 41. In the imaging lens 2 illustrated in FIG. 7, optical paths at the temperature of 20° C. are also illustrated. FIG. 8 is a diagram illustrating Diffraction MTF (temperature of 20° C.) of the imaging lens 2 according to Example 1. FIG. 9 is a diagram illustrating optical paths at the temperature of 65° C. in the imaging lens 2 illustrated in FIG. 7. FIG. 10 is a diagram illustrating Diffraction MTF (temperature of 65° C.) of the imaging lens 2 according to Example 1. FIGS. 11A, 11B, 11C, and 11D are aberration diagrams of the imaging lens 2 at the temperature of 20° C. according to Example 1.

FIG. 11A illustrates an aberration diagram of an astigmatism with reference to an imaging surface, and the horizontal axis illustrates an astigmatism and the vertical axis illustrates the size of an aberration. FIG. 11A illustrates a case where 18.605° of DFOV that is the diagonal angle of view of the imaging lens 2 is the maximum image height. In the aberration diagram of the imaging lens 2 illustrated in FIG. 11A, an aberration amount on a tangential surface at Wavelength: 550 nm is illustrated with a solid line, and an aberration amount on a sagittal surface is illustrated with a dotted line. The tangential surface is a surface including a principal ray passing through the imaging lens 2 and the optical axis of the imaging lens 2. The sagittal surface is a surface including a principal ray passing through the imaging lens 2 and perpendicular to the tangential surface.

FIG. 11B illustrates an aberration diagram of a spherical aberration with reference to the imaging surface, and the horizontal axis illustrates a spherical aberration and the vertical axis illustrates the size of an aberration. FIG. 11B illustrates a case of “F-number Fno=2.979”. In the aberration diagram of the optical system of the lens group 21 illustrated in FIG. 11B, an aberration amount for Wavelength: 650 nm is illustrated with a dashed-dotted line, an aberration amount for Wavelength: 555 nm is illustrated with a solid line, and an aberration amount for Wavelength: 470 nm is illustrated with a dotted line.

FIG. 11C illustrates an aberration diagram of a distortion aberration with reference to the imaging surface, and the horizontal axis illustrates a distortion aberration and the vertical axis illustrates the size of an aberration. FIG. 11C illustrates a case where 18.605° of DFOV that is the diagonal angle of view of the imaging lens 2 is the maximum image height. In the aberration diagram of the imaging lens 2 illustrated in FIG. 11C, an aberration amount for Wavelength: 550 nm is illustrated with a solid line.

FIG. 11D illustrates an aberration diagram of a chromatic aberration of magnification with reference to the imaging surface, and the horizontal axis illustrates a chromatic aberration of magnification and the vertical axis illustrates the size of an aberration. FIG. 11D illustrates a case where 18.605° of DFOV that is the diagonal angle of view of the imaging lens 2 is the maximum image height. In the aberration diagram of the imaging lens 2 illustrated in FIG. 11D, an aberration amount on the sagittal surface for Wavelength: 550 nm is illustrated with a solid line, and an aberration amount on the tangential surface is illustrated with a dotted line.

The optical settings of the imaging lens 2 according to Example 1 are indicated by Table 4 to Table 11. Table 4 to Table 9 are data at the temperature of 20° C., and Table 10 and Table 11 are data at the temperature of 65° C.

TABLE 4

| | SURFACE | | | | | GLASS | | | | | | |
|---|---|---|---|---|---|---|---|---|---|---|---|---|
| | NUMBER | R | D | Nd | Vd | MATERIAL | FOCAL LENGTH | | | | | |
| | 0 | INF | INF | | | | | | | | | |
| | 1 | INF | 1.200 | | | | | | | | | |
| DIAPHRAGM | STO | INF | −1.200 | | | | | | | | | |
| L1 | 3 | 8.108 | 1.511 | 1.552 | 70.70 | GLASS | 18.892 | | 6.902 | 24.787 | f_F | |
| | 4 | 34.211 | 0.050 | | | | | | | | | |
| L2 | 5 | 6.369 | 1.638 | 1.544 | 56.33 | PLASTIC | 10.029 | −32.695 | | | | f_B |
| | 6 | −34.356 | 0.050 | | | | | | | | | |
| L3 | 7 | 39.990 | 0.500 | 1.593 | 28.27 | PLASTIC | −13.296 | | −6.261 | | f_B2 | |
| | 8 | 6.489 | 0.887 | | | | | | | | | |
| L4 | 9 | −21.110 | 0.500 | 1.544 | 56.33 | PLASTIC | −12.759 | | | | | |
| | 10 | 10.411 | 0.854 | | | | | | | | | |
| REFLECTIVE LIGHT | 11 | INF | 21.097 | 1.517 | 64.17 | GLASS | | | | | | |
| GUIDE ELEMENT | | | | | | | | | | | | |
| | 12 | INF | 0.345 | | | | | | | | | |
| IR GLASS | 13 | INF | 0.210 | 1.517 | 64.17 | GLASS | | | | | | |
| | 14 | INF | 0.350 | | | | | | | | | |
| | 15 | INF | 0.000 | | | | | | | | | |

Table 4 illustrates R (curvature radius), D (interval), Nd (refractive index), Vd (ABBE Number), glass materials, and focal length.

Moreover, Table 4 illustrates, outside the table, positions of the diaphragm 11, the lenses of the lens group 21, the reflective light guide element 31, and an IR glass 41. For example, the data of “STO” illustrated in “Surface number” is data of the diaphragm 11. The data of “3” and “4” illustrated in “Surface number” is data of the first lens L1. “3” is data of the object-side surface, and “4” is data of the image-side surface. Similarly, the data of “5” and “6” illustrated in “Surface number” is data of the second lens L2. “5” is data of the object-side surface, and “6” is data of the image-side surface. The data of “7” and “8” illustrated in “Surface number” is data of the third lens L3. “7” is data of the object-side surface, and “8” is data of the image-side surface. The data of “9” and “10” illustrated in “Surface number” is data of the fourth lens L4. “9” is data of the object-side surface, and “10” is data of the image-side surface.

The data of “11” illustrated in “Surface number” is data of the reflective light guide element 31. The data of “13” illustrated in “Surface number” is data of the IR glass 41.

Moreover, in Table 4, “f_B2” indicates the focal length of the rear two lenses. “f_F” indicates the focal length of the front lenses other than the rear two lenses. Because the imaging lens 2 according to Example 1 includes the lens group 21 having a four-piece configuration, “f_F” is the focal length of the first lens L1 and the second lens L2 that are the front two lenses. “f_B” indicates the focal length of plastic lenses other than glass material. Because the imaging lens 2 according to Example 1 includes the first lens L1 made of glass material, f_B is the focal length of the second lens L2 to the fourth lens L4.

Note that the viewpoint of these data is similar in other Examples.

TABLE 5
25° C. REFRACTIVE INDEX

| WAVELENGTH [nm] | 656.3 | 546.1 | 435.8 |
|---|---|---|---|
| L1 | 1.5496300 | 1.5538600 | 1.5616700 |
| L2 | 1.5416200 | 1.5467900 | 1.5567200 |
| L3 | 1.5821000 | 1.5928000 | 1.6157000 |
| L4 | 1.5416200 | 1.5467900 | 1.5567200 |
| REFLECTIVE | 1.5147270 | 1.5191302 | 1.5270993 |
| LIGHT GUIDE | | | |
| ELEMENT | | | |
| COLOR CORRECTION | 1.5147270 | 1.5191302 | 1.5270993 |
| MEMBER | | | |

Table 5 illustrates the refractive indices of the optical elements for the temperature of 25° C. Table 5 illustrates the refractive indices of light for three wavelengths as an example.

TABLE 6
GLASS MATERIAL dn/dt

| WAVELENGTH [nm] | 656.3 | 546.1 | 435.8 |
|---|---|---|---|
| L1 | −2.900.E−06 | −2.600.E−06 | −2.100.E−06 |
| L2 | −1.002.E−04 | −1.010.E−04 | −1.027.E−04 |
| L3 | −1.002.E−04 | −1.010.E−04 | −1.027.E−04 |
| L4 | −1.002.E−04 | −1.010.E−04 | −1.027.E−04 |
| REFLECTIVE | 1.400.E−06 | 1.600.E−06 | 2.100.E−06 |
| LIGHT GUIDE | | | |
| ELEMENT | | | |
| COLOR CORRECTION | 1.400.E−06 | 1.600.E−06 | 2.100.E−06 |
| MEMBER | | | |

Table 6 illustrates a change in the refractive index with temperature illustrated in Table 5 for the temperature of 25° C. A refractive index change dn when a temperature t is changed by 1° C. is indicated by a plus numerical value for the increment and is indicated by a minus numerical value for the decrement, every optical element. The refractive index change dn is extremely small for the first lens L1 and the reflective light guide element 31 made of glass and the IR glass 41 that is the color correction member. On the other hand, the second lens L2 to the fourth lens L4 made of plastic have a great change.

TABLE 7

| SURFACE | | | | | | | | |
|---|---|---|---|---|---|---|---|---|
| NUMBER | 3 | 4 | 5 | 6 | 7 | 8 | 9 | 10 |
| K | 0 | 0 | 1.537248 | 13.988195 | 28.187124 | 2.145242 | −7.093813 | 11.826309 |
| A4 | 0 | 0 | 2.567003.E−04 | 1.418899.E−02 | 7.513145.E−03 | −7.625068.E−03 | 4.206922.E−03 | 5.472435.E−03 |
| A6 | 0 | 0 | −2.481986.E−04 | −9.800943.E−03 | −6.812952.E−03 | 5.539898.E−03 | 3.812594.E−03 | 2.230445.E−03 |
| A8 | 0 | 0 | 6.134764.E−05 | 4.033613.E−03 | 3.207014.E−03 | −2.530270.E−03 | −2.851887.E−03 | −2.407981.E−03 |
| A10 | 0 | 0 | −1.265814.E−05 | −9.928612.E−04 | −8.225498.E−04 | 8.712304.E−04 | 1.139470.E−03 | 1.113978.E−03 |
| A12 | 0 | 0 | 1.771225.E−06 | 1.530156.E−04 | 1.275023.E−04 | −1.928147.E−04 | −2.828093.E−04 | −3.231439.E−04 |
| A14 | 0 | 0 | −1.784275.E−07 | −1.493838.E−05 | −1.226385.E−05 | 2.595042.E−05 | 4.414572.E−05 | 5.974716.E−05 |
| A16 | 0 | 0 | 1.193998.E−08 | 8.993512.E−07 | 7.152228.E−07 | −1.965176.E−06 | −4.194201.E−06 | −6.843520.E−06 |
| A18 | 0 | 0 | −4.650026E−10 | −3.053125E−08 | −2.316540E−08 | 6.931212E−08 | 2.203461E−07 | 4.425130E−07 |
| A20 | 0 | 0 | 7.711405E−12 | 4.482260E−10 | 3.205945E−10 | −5.585099E−10 | −4.882738E−09 | −1.238846E−08 |

Table 7 illustrates the shape data of aspheric surfaces of the lenses (Surface number 3 to Surface number 10) of the lens group 21 for the temperature of 25° C.

TABLE 8

| PARAMETER | INF | UNIT |
|---|---|---|
| LTL | 27.992 | mm |
| da | 8.320 | mm |
| L | 5.990 | mm |
| EPD | 5.958 | mm |
| DFOV | 18.605 | deg |
| dd | 4.096 | mm |
| EPT | −17.527 | mm |
| EFL | 24.787 | mm |
| FNO | 2.979 | |
| f_B2 | −6.261 | mm |
| f_F | 6.902 | mm |
| f_B2/f_F | −0.907 | |
| EFL/dd | 6.052 | |
| EPT/PL | −0.831 | |
| EPD/Pref_d | 1.954 | |
| EFL1/EFL | 0.762 | |
| f_B/EFL1 | −1.73 | |
| 1/EFL1 | 0.0529 | |

Table 8 illustrates data of main parameters of the entire imaging lens 2 for the temperature of 25° C. Herein, “LTL” is a parameter indicating the total length of the lens. The total length of the lens is a total optical path length from the lens vertex of the first surface of the first lens L1 to the sensor surface. “da” is a parameter indicating the diameter of the diaphragm 11. “DFOV” is a parameter indicating the diagonal FOV of the lens. “dd” is a parameter indicating the half size of the sensor surface in a diagonal direction. “FNO” is F-number. “EFL1” is the focal length of the first lens L1 made of glass material in Example 1. “f_B/EFL1” is a refractive index ratio of glass material and plastic material.

TABLE 9
REFLECTIVE LIGHT GUIDE ELEMENT

| PARAMETER | INF | UNIT |
|---|---|---|
| Pref_d | 3.050 | mm |
| P_t | 5.000 | mm |
| θ | 33.0 | deg |
| P_od | 13.701 | mm |
| PL: PRISM OPTICAL | 21.097 | mm |
| LENGTH | | |

Table 9 is data of parameters associated with the reflective light guide element 31 for the temperature of 25° C.

TABLE 10

| | SURFACE | | |
|---|---|---|---|
| | NUMBER | R | D |
| | 0 | INF | INF |
| | 1 | INF | 1.2000 |
| DIAPHRAGM | STO | INF | −1.2000 |
| L1 | 3 | 8.1119 | 1.5114 |
| | 4 | 34.2271 | 0.0540 |
| L2 | 5 | 6.3865 | 1.6424 |
| | 6 | −34.4517 | 0.0507 |
| L3 | 7 | 40.1104 | 0.5015 |
| | 8 | 6.5088 | 0.8846 |
| L4 | 9 | −21.1691 | 0.5014 |
| | 10 | 10.4402 | 0.8543 |
| REFLECTIVE LIGHT | 11 | INF | 21.1036 |
| GUIDE ELEMENT | | | |
| | 12 | INF | 0.3453 |
| IR GLASS | 13 | INF | 0.2101 |
| | 14 | INF | 0.3504 |
| | 15 | INF | 0.0000 |

Table 10 is comparison data with Table 4. Table 10 illustrates values of R and values D extracted at the temperature of 65° C.

TABLE 11

| SURFACE | | | | | | | | |
|---|---|---|---|---|---|---|---|---|
| NUMBER | 3 | 4 | 5 | 6 | 7 | 8 | 9 | 10 |
| K | 0 | 0 | 1.537248 | 13.988195 | 28.187124 | 2.145242 | −7.093813 | 11.826309 |
| A4 | 0 | 0 | 2.545599.E−04 | 1.407068.E−02 | 7.445707.E−03 | −7.556626.E−03 | 4.171844.E−03 | 5.426804.E−03 |
| A6 | 0 | 0 | −2.447589.E−04 | −9.665116.E−03 | −6.711336.E−03 | 5.457270.E−03 | 3.759757.E−03 | 2.199535.E−03 |
| A8 | 0 | 0 | 6.016068.E−05 | 3.955570.E−03 | 3.140248.E−03 | −2.477594.E−03 | −2.796708.E−03 | −2.361391.E−03 |
| A10 | 0 | 0 | −1.234413.E−05 | −9.682313.E−04 | −8.005986.E−04 | 8.479801.E−04 | 1.111203.E−03 | 1.086344.E−03 |
| A12 | 0 | 0 | 1.717671.E−06 | 1.483891.E−04 | 1.233559.E−04 | −1.865444.E−04 | −2.742584.E−04 | −3.133735.E−04 |
| A14 | 0 | 0 | −1.720694.E−07 | −1.440606.E−05 | −1.179393.E−05 | 2.495606.E−05 | 4.257264.E−05 | 5.761814.E−05 |
| A16 | 0 | 0 | 1.145042.E−08 | 8.624758.E−07 | 6.836950.E−07 | −1.878549.E−06 | −4.022229.E−06 | −6.562920.E−06 |
| A18 | 0 | 0 | −4.434541E−10 | −2.911641E−08 | −2.201154E−08 | 6.585969E−08 | 2.101351E−07 | 4.220066E−07 |
| A20 | 0 | 0 | 7.313116E−12 | 4.250755E−10 | 3.028002E−10 | −5.275102E−10 | −4.630548E−09 | −1.174860E−08 |

Table 11 is comparison data with Table 7. Table 11 illustrates shape data of an aspheric surface of the lens (Surface number 3 to Surface number 10) in the lens group 21 for the temperature of 65° C.

Explanation of Example 1 being Optical setting effective for suppressing Defocus due to Temperature

The imaging lens 2 according to Example 1 has a configuration of a ½ inch-size sensor, a telephoto lens with a 35 mm equivalent focal length of 131 mm, F number 3.0, and three reflections in the reflective light guide element 31, but the defocus due to temperature does not nearly occurs at the temperature of 20° C. and the temperature of 65° C., as illustrated by Diffraction MTF (temperature of 20° C.) illustrated in FIG. 8 and Diffraction MTF (temperature of 65° C.) illustrated in FIG. 10. Moreover, it turns out that each aberration is properly adjusted from FIGS. 11A, 11B, 11C, and 11D.

Therefore, it can be said that Example 1 is one of the optical settings effective for suppressing the defocus due to temperature.

### Example 2

Also in the following, Diffraction MTF has a result that the defocus due to temperature does not nearly occurs. For this reason, without performing illustration of Diffraction MTF and table comparison between different temperatures, a configuration diagram of an imaging lens 3 according to Example 2, a table indicating data at a predetermined temperature, and an aberration diagram are illustrated. A table indicating the refractive indices of a reflective light guide element 32 according to Example 2 is similar to Example 1.

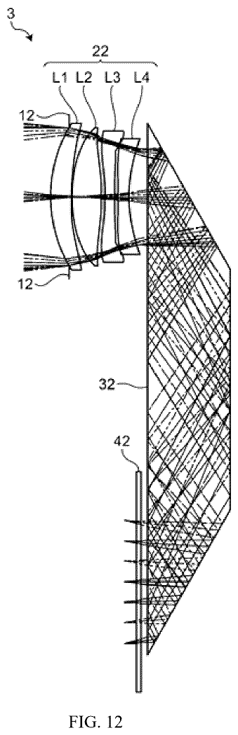

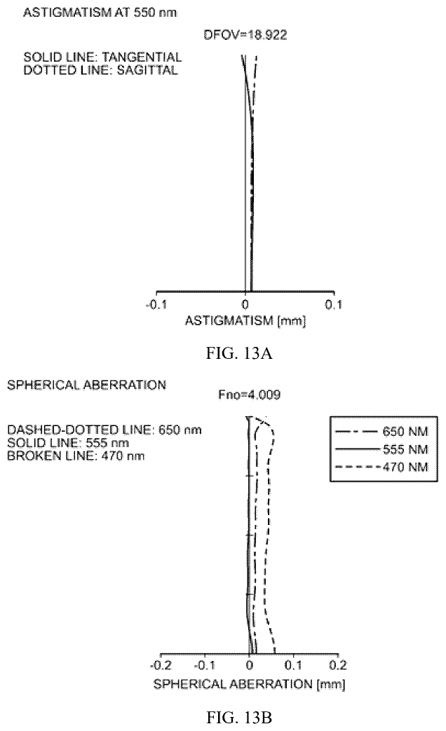

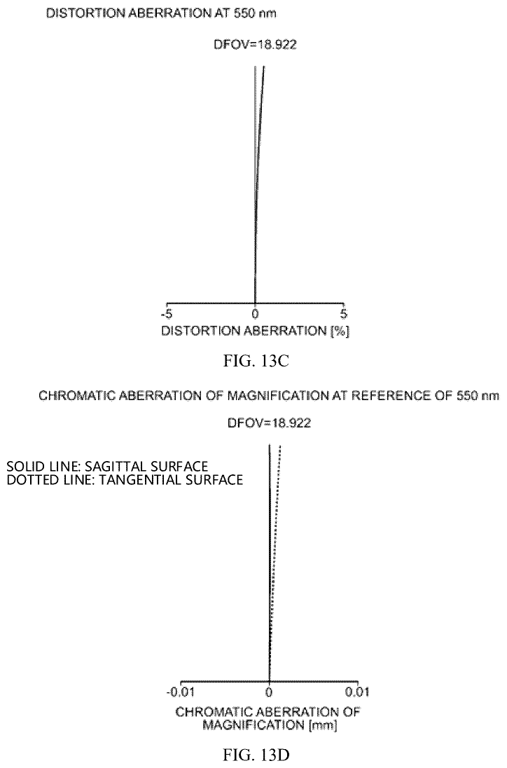

FIG. 12 is a diagram illustrating an example of a configuration of the imaging lens 3 according to Example 2. The imaging lens 3 illustrated in FIG. 12 includes a diaphragm 12, a lens group 22, and the reflective light guide element 32. The light from the object side passes through the diaphragm 12, the lens group 22, and the reflective light guide element 32 in this order, and is emitted toward an IR filter 42. FIGS. 13A, 13B, 13C, and 13D are aberration diagrams of the imaging lens 3 according to Example 2. The optical settings of the imaging lens 3 according to Example 2 are illustrated by Table 12 to Table 15.

TABLE 12

| | SURFACE | | | | | GLASS | | | | | | |
|---|---|---|---|---|---|---|---|---|---|---|---|---|
| | NUMBER | R | D | Nd | Vd | MATERIAL | FOCAL LENGTH | | | | | |
| | 0 | INF | INF | | | | | | | | | |
| | 1 | INF | 0.800 | | | | | | | | | |
| DIAPHRAGM | STO | INF | −0.800 | | | | | | | | | |
| L1 | 3 | 6.251 | 0.873 | 1.702 | 41.14 | GLASS | 20.147 | | 5.305 | 24.257 | f_F | |
| | 4 | 10.587 | 0.050 | | | | | | | | | |
| L2 | 5 | 6.799 | 1.278 | 1.544 | 56.33 | PLASTIC | 6.621 | −48.469 | | | | f_B |
| | 6 | −7.136 | 0.119 | | | | | | | | | |
| L3 | 7 | −24.328 | 0.416 | 1.593 | 28.27 | PLASTIC | −25.843 | | −4.907 | | f_B2 | |
| | 8 | 40.339 | 0.167 | | | | | | | | | |
| L4 | 9 | −9.410 | 0.400 | 1.567 | 37.56 | PLASTIC | −6.171 | | | | | |
| | 10 | 5.632 | 0.897 | | | | | | | | | |
| REFLECTIVE LIGHT | 11 | INF | 23.500 | 1.517 | 64.17 | GLASS | | | | | | |
| GUIDE ELEMENT | | | | | | | | | | | | |
| | 12 | INF | 0.300 | | | | | | | | | |
| IR GLASS | 13 | INF | 0.210 | 1.517 | 64.17 | GLASS | | | | | | |
| | 14 | INF | 0.490 | | | | | | | | | |
| | 15 | INF | 0.000 | | | | | | | | | |

TABLE 13

| SURFACE | | | | | | | | |
|---|---|---|---|---|---|---|---|---|
| NUMBER | 3 | 4 | 5 | 6 | 7 | 8 | 9 | 10 |
| K | 0 | 0 | −23.154560 | −32.775668 | 60.585169 | 62.437265 | −57.111072 | 3.484979 |
| A4 | 0 | 0 | 1.105636.E−02 | 8.107849.E−03 | 9.709437.E−05 | −1.133146.E−03 | 4.782779.E−02 | 3.733761.E−02 |
| A6 | 0 | 0 | −2.085167.E−03 | −2.831934.E−03 | 1.837061.E−03 | 1.773206.E−02 | −1.274865.E−02 | −2.302187.E−02 |
| A8 | 0 | 0 | 6.891310.E−04 | 5.694805.E−04 | −3.811549.E−03 | −1.831255.E−02 | −2.273817.E−03 | 9.293432.E−03 |
| A10 | 0 | 0 | −2.117870.E−04 | −1.868306.E−04 | 2.061605.E−03 | 8.641764.E−03 | 1.941890.E−03 | −3.132661.E−03 |
| A12 | 0 | 0 | 5.044861.E−05 | 8.865052.E−05 | −5.354420.E−04 | −2.328871.E−03 | −4.064534.E−04 | 8.078013.E−04 |
| A14 | 0 | 0 | −8.484776.E−06 | −2.356101.E−05 | 7.787874.E−05 | 3.839766.E−04 | 2.011845.E−05 | −1.440241.E−04 |
| A16 | 0 | 0 | 9.558471.E−07 | 3.257295.E−06 | −6.474608.E−06 | −3.831439.E−05 | 5.282340.E−06 | 1.601567.E−05 |
| A18 | 0 | 0 | −6.506953E−08 | −2.275678E−07 | 2.893972E−07 | 2.109432E−06 | −8.925198E−07 | −9.639359E−07 |
| A20 | 0 | 0 | 1.993748E−09 | 6.440654E−09 | −5.488988E−09 | −4.679364E−08 | 4.309155E−08 | 2.199342E−08 |

TABLE 14

| PARAMETER | INF | UNIT |
|---|---|---|
| LTL | 28.700 | mm |
| da | 6.050 | mm |
| L | 4.200 | mm |
| EPD | 4.627 | mm |
| DFOV | 18.922 | deg |
| dd | 4.096 | mm |
| EPT | −18.541 | mm |
| EFL | 24.257 | mm |
| FNO | 4.009 | |
| f_B2 | −4.907 | mm |
| f_F | 5.305 | mm |
| f_B2/f_F | −0.925 | |
| EFL/dd | 5.922 | |
| EPT/PL | −0.789 | |
| EPD/Pref_d | 2.625 | |
| EFL1/EFL | 0.831 | |
| f_B/EFL1 | −2.41 | |
| 1/EFL1 | 0.0496 | |

TABLE 15
REFLECTIVE LIGHT GUIDE ELEMENT

| PARAMETER | INF | UNIT |
|---|---|---|
| Pref_d | 1.763 | mm |
| P_t | 3.530 | mm |
| θ | 29.0 | deg |
| P_od | 16.938 | mm |
| PL: PRISM OPTICAL | 23.500 | mm |
| LENGTH | | |

The imaging lens 3 according to Example 2 has a configuration of a ½ inch-size sensor, a telephoto lens with a 35 mm equivalent focal length of 128 mm, F-number 4.0, and five reflections in the reflective light guide element 32. Even in this configuration, the defocus due to temperature does not nearly occur. Moreover, it turns out that each aberration is properly adjusted from FIGS. 13A, 13B, 13C, and 13D.

Therefore, it can be said that Example 2 is one of the optical settings effective for suppressing the defocus due to temperature.

### Example 3

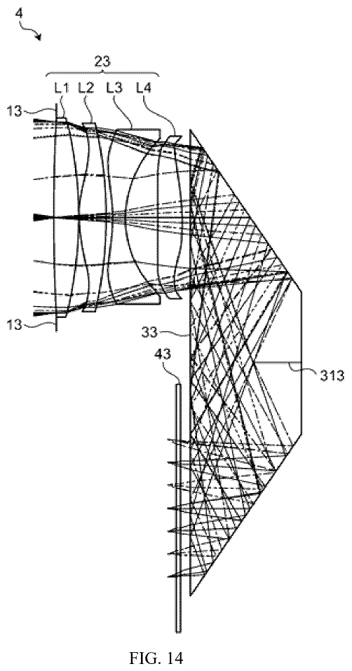

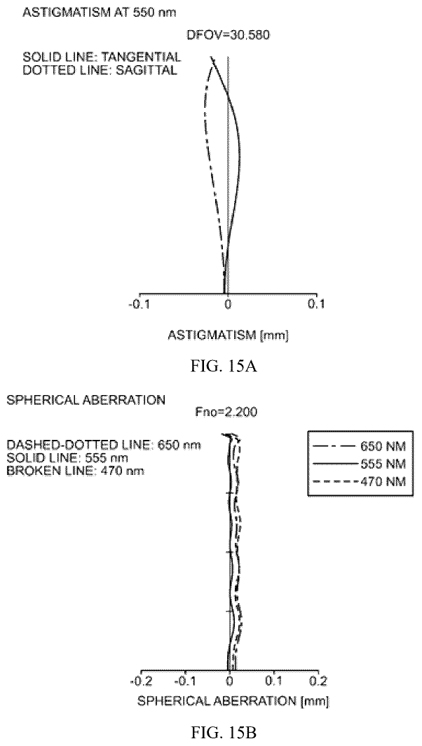

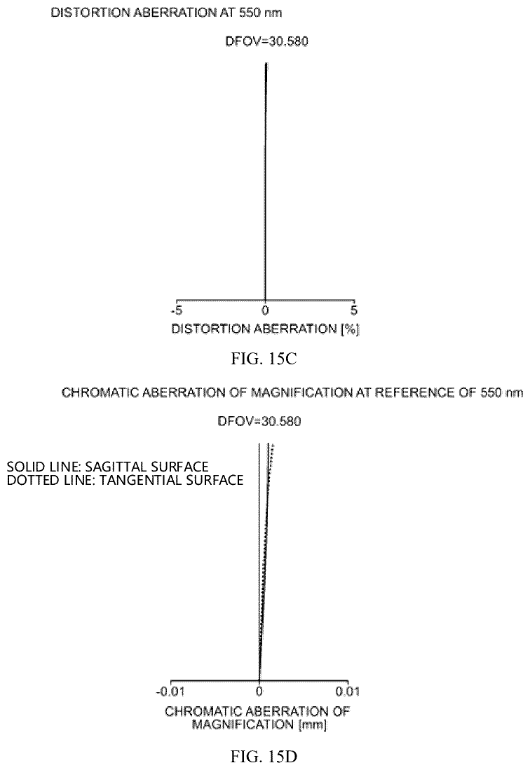

FIG. 14 is a diagram illustrating an example of a configuration of an imaging lens 4 according to Example 3. The imaging lens 4 illustrated in FIG. 14 includes a diaphragm 13, a lens group 23, and a reflective light guide element 33. Moreover, the reflective light guide element 33 includes a ray cut part 313. The light from the object side passes through the diaphragm 13, the lens group 23, and the reflective light guide element 33 in this order, and is emitted toward an IR filter 43. FIGS. 15A, 15B, 15C, and 15D are aberration diagrams of the imaging lens 4 according to Example 3. The optical settings of the imaging lens 4 according to Example 3 are illustrated by Table 16 to Table 19.

TABLE 16

| | SURFACE | | | | | GLASS | | | | | | |
|---|---|---|---|---|---|---|---|---|---|---|---|---|
| | NUMBER | R | D | Nd | Vd | MATERIAL | FOCAL LENGTH | | | | | |
| | 0 | INF | INF | | | | | | | | | |
| | 1 | INF | 0.100 | | | | | | | | | |
| DIAPHRAGM | STO | INF | −0.100 | | | | | | | | | |
| L1 | 3 | 91.420 | 1.100 | 1.911 | 35.25 | GLASS | 16.803 | | 3.965 | 18.718 | f_F | |
| | 4 | −18.210 | 0.025 | | | | | | | | | |
| L2 | 5 | 6.698 | 1.267 | 1.593 | 28.27 | PLASTIC | 5.002 | −118.161 | | | | f_B |
| | 6 | −4.846 | 0.201 | | | | | | | | | |
| L3 | 7 | −6.275 | 0.500 | 1.641 | 23.97 | PLASTIC | −3.203 | | −4.644 | | f_B2 | |
| | 8 | 3.082 | 1.478 | | | | | | | | | |
| L4 | 9 | 122.675 | 1.078 | 1.544 | 56.33 | PLASTIC | 17.491 | | | | | |
| | 10 | −10.272 | 0.350 | | | | | | | | | |
| REFLECTIVE LIGHT | 11 | INF | 19.301 | 1.517 | 64.17 | GLASS | | | | | | |
| GUIDE ELEMENT | | | | | | | | | | | | |
| | 12 | INF | 0.400 | | | | | | | | | |
| IR GLASS | 13 | INF | 0.210 | 1.517 | 64.17 | GLASS | | | | | | |
| | 14 | INF | 0.380 | | | | | | | | | |
| | 15 | INF | 0.000 | | | | | | | | | |

TABLE 17

| SURFACE | | | | | | | | |
|---|---|---|---|---|---|---|---|---|
| NUMBER | 3 | 4 | 5 | 6 | 7 | 8 | 9 | 10 |
| K | 0 | 0 | −8.263758 | −3.741468 | −30.550039 | −0.650291 | −82.276022 | −0.027002 |
| A4 | 0 | 0 | 2.044511.E−03 | 2.611657.E−02 | 4.399243.E−03 | −2.010352.E−02 | −2.561398.E−03 | −3.225273.E−04 |
| A6 | 0 | 0 | −3.998163.E−04 | −8.904120.E−03 | −1.431080.E−03 | 6.557158.E−03 | 6.228452.E−04 | 1.401091.E−04 |
| A8 | 0 | 0 | 1.116810.E−05 | 2.283568.E−03 | 5.683302.E−04 | −1.913231.E−03 | −9.311893.E−05 | −1.292692.E−05 |
| A10 | 0 | 0 | 1.163770.E−05 | −4.170896.E−04 | −1.440308.E−04 | 4.109112.E−04 | 1.780536.E−05 | 3.582837.E−06 |
| A12 | 0 | 0 | −4.927041.E−06 | 5.051786.E−05 | 2.345968.E−05 | −6.033960.E−05 | −1.838022.E−06 | −3.047739.E−07 |
| A14 | 0 | 0 | 7.376363.E−07 | −3.921896.E−06 | −2.336408.E−06 | 5.856978.E−06 | 9.635178.E−08 | 7.672826.E−09 |
| A16 | 0 | 0 | −5.278788.E−08 | 1.874660.E−07 | 1.367208.E−07 | −3.604779.E−07 | −1.955518.E−09 | 3.202004.E−10 |
| A18 | 0 | 0 | 1.853821E−09 | −5.025201E−09 | −4.323347E−09 | 1.278248E−08 | 0 | 0 |
| A20 | 0 | 0 | −2.584875E−11 | 5.781449E−11 | 5.710160E−11 | −1.996592E−10 | 0 | 0 |

TABLE 18

| PARAMETER | INF | UNIT |
|---|---|---|
| LTL | 26.291 | mm |
| da | 8.508 | mm |
| L | 6.000 | mm |
| EPD | 8.346 | mm |
| DFOV | 30.580 | deg |
| dd | 5.120 | mm |
| EPT | −18.078 | mm |
| EFL | 18.718 | mm |
| FNO | 2.200 | |
| f_B2 | −4.644 | mm |
| f_F | 3.965 | mm |
| f_B2/f_F | −1.171 | |
| EFL/dd | 3.656 | |
| EPT/PL | −0.937 | |
| EPD/Pref_d | 3.173 | |
| EFL1/EFL | 0.898 | |
| f_B/EFL1 | −7.03 | |
| 1/EFL1 | 0.0595 | |

TABLE 19
REFLECTIVE LIGHT GUIDE ELEMENT

| PARAMETER | INF | UNIT |
|---|---|---|
| Pref_d | 2.630 | mm |
| P_t | 5.000 | mm |
| θ | 34.0 | deg |
| P_od | 13.019 | mm |
| PL: PRISM OPTICAL | 19.301 | mm |
| LENGTH | | |

The imaging lens 4 according to Example 3 has a configuration of a 1/1.56 inch-size sensor, a telephoto lens with a 35 mm equivalent focal length of 79 mm, F-number 2.2, and three reflections in the reflective light guide element 33. Even in this configuration, the defocus due to temperature does not nearly occur. Moreover, it turns out that each aberration is properly adjusted from FIGS. 15A, 15B, 15C, and 15D.

Therefore, it can be said that Example 3 is one of the optical settings effective for suppressing the defocus due to temperature.

### First Modification Example of First Embodiment

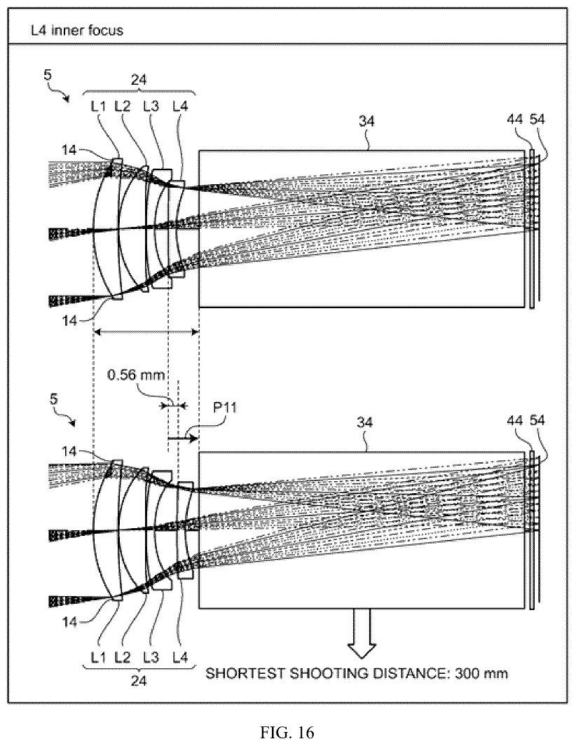

The lens group 20 of the imaging lens 1 in FIG. 4 may have a configuration of moving the entire lens group, or may have a configuration of moving some of the lenses. Herein, the brief description for an inner focus method that is one of modification examples of the first embodiment is performed by using a simplified imaging lens 5 illustrated in FIG. 16. Note that the explanation common with the imaging lens according to the first embodiment is omitted as appropriate, and points different from the imaging lens according to the first embodiment will be described.

FIG. 16 is an explanatory diagram illustrating an imaging lens 5 according to a first modification example of the first embodiment. The imaging lens 5 illustrated in FIG. 16 includes a diaphragm 14, a lens group 24, and a reflective light guide element 34. The light from the object side passes through the diaphragm 14, the lens group 24, and the reflective light guide element 34 in this order, and is emitted to an imaging element 54 via an IR filter 44.

The reflective light guide element 34 is similar to a configuration of the reflective light guide element 30 with odd number of reflections illustrated in FIG. 4. In FIG. 16, for brief description, the optical path of the reflective light guide element 34 is linearly illustrated to illustrate the configuration in a simplified form.

In the configuration of the imaging lens 5 illustrated in FIG. 16, the fourth lens L4 that is the final lens is driven among the four lenses as an example. The fourth lens L4 is moved by the VCM drive in a lens optical axis direction P11. In an example of the configuration, when the movement distance of the fourth lens L4 is 0.56 mm, the shortest shooting distance is 300 mm.

In the case of the inner focus method, the lens focuses on the object closer when shooting is performed on the telephoto side by the telephoto lens like the present suggestion. Because a depth of field is shallow, the lens focuses on the object, and the background can be taken more blurred. As described above, if it is the imaging lens 5 according to the first modification example, the usage such as macro shooting of a single-lens reflex camera is also enabled.

Moreover, when the inner focus is employed like the first modification example, it is not necessary to provide a space for the lens to extend between the cover glass and the first lens L1. For this reason, the first lens L1 can be arranged to bring it closer to the cover glass side, and thus the thickness from the cover glass becomes advantageous. In other words, because the entire lens is not extended when the inner focus is employed, a space of the extension part is not necessary, and thus further thinning can be expected. Alternatively, by using the space, it is possible to raise the performance of another part or to further add a diaphragm mechanism.

### Example According to First Modification Example: Example 4

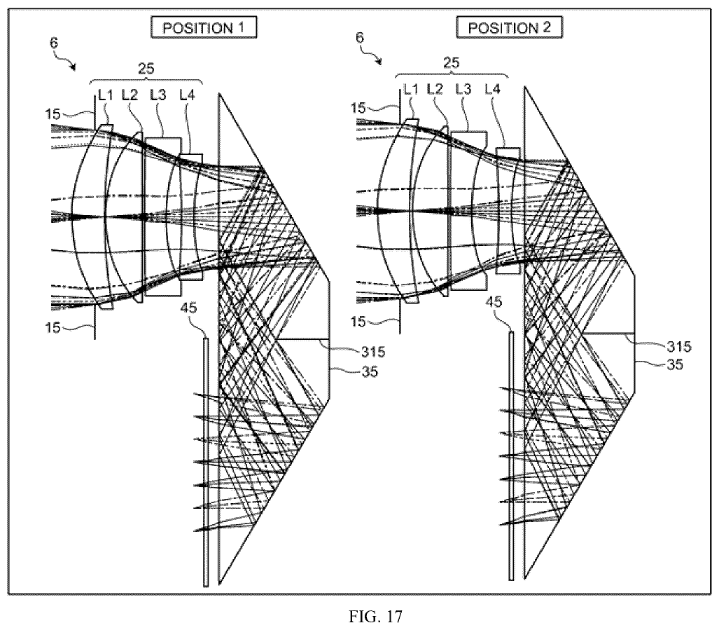

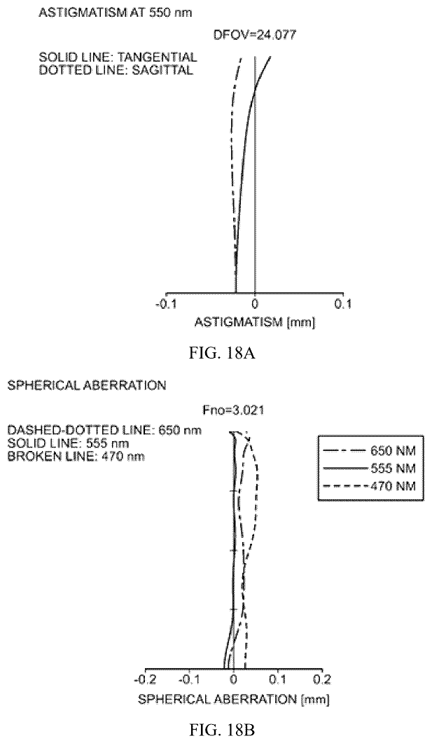

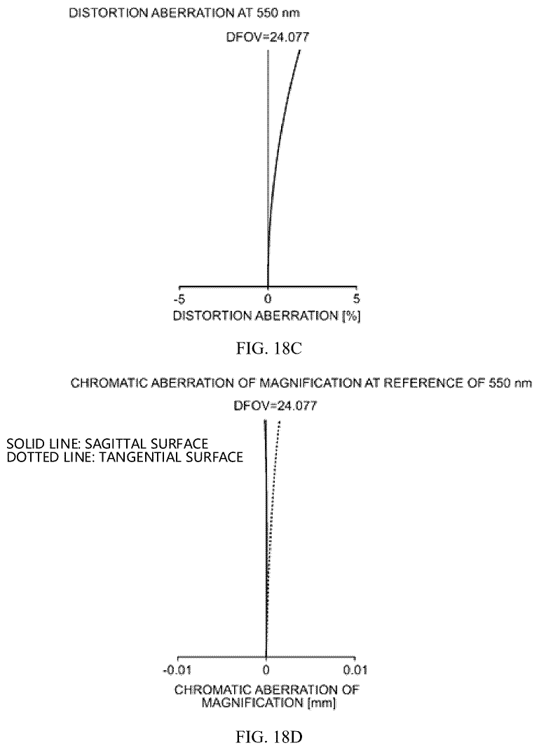

FIG. 17 is a diagram illustrating an example of a configuration of an imaging lens 6 according to Example 4. The imaging lens 6 illustrated in FIG. 17 includes a diaphragm 15, a lens group 25, and a reflective light guide element 35. Moreover, the reflective light guide element 35 includes a ray cut part 315. The light from the object side passes through the diaphragm 15, the lens group 25, and the reflective light guide element 35 in this order, and is emitted toward an IR filter 45. FIGS. 18A, 18B, 18C, and 18D are aberration diagrams of the imaging lens 6 according to Example 4. The optical settings of the imaging lens 6 according to Example 4 are illustrated by Table 20 to Table 24.

As illustrated in FIG. 17, the fourth lens L4 takes two positions by the inner focus. The fourth lens L4 moves from Position 1 to Position 2.

TABLE 20

| SURFACE | | | | | GLASS | | | | | | |
|---|---|---|---|---|---|---|---|---|---|---|---|
| NUMBER | R | D | Nd | Vd | MATERIAL | FOCAL LENGTH | | | | | |
| 0 | INF | ZOOM 1 | | | | | | | | | |
| 1 | INF | 1.000 | | | | | | | | | |
| STO | INF | −1.000 | | | | | | | | | |
| 3 | 7.140 | 1.439 | 1.517 | 64.20 | GLASS | 19.693 | | 6.762 | 23.561 | f_F | |
| 4 | 22.372 | 0.050 | | | | | | | | | |
| 5 | 6.610 | 1.655 | 1.544 | 56.33 | PLASTIC | 9.427 | −40.188 | | | | f_B |
| 6 | −20.756 | 0.091 | | | | | | | | | |
| 7 | −22.910 | 0.924 | 1.593 | 28.27 | PLASTIC | −12.726 | | −6.206 | | f_B2 | |
| 8 | 11.216 | 0.700 | | | | | | | | | |
| 9 | INF | ZOOM 2 | | | | | | | | | |
| 10 | −8.815 | 0.528 | 1.544 | 56.33 | PLASTIC | −13.022 | | | | | |
| 11 | 36.6499 | 1.113 | | | | | | | | | |
| 12 | INF | ZOOM 3 | | | | | | | | | |
| 13 | INF | 19.000 | 1.517 | 64.17 | GLASS | | | | | | |
| 14 | INF | 0.500 | | | | | | | | | |
| 15 | INF | 0.210 | 1.517 | 64.17 | GLASS | | | | | | |
| 16 | INF | 0.410 | | | | | | | | | |
| 17 | INF | 0.000 | | | | | | | | | |

Table 20 includes Zoom 1, Zoom 2, and Zoom 3. Zoom 1 indicates a distance from a vertex of the first lens L1 to the object. Zoom 2 indicates an interval from the third lens L3 to the fourth lens LA. Zoom 3 indicates an interval from the fourth lens L4 to the incident surface of the reflective light guide element 35.

Zoom 1 is INF (infinity) at Position 1, but is the shortest shooting distance at Position 2. Zoom 2 and Zoom 3 are together 0 at Position 1, but Zoom 2 becomes wide and Zoom 3 becomes narrow at Position 2.

TABLE 21

| | POSITION 1 | POSITION 2 |
|---|---|---|
| ZOOM 1 | INF | 300 |
| ZOOM 2 | 0.000 | 0.524 |
| ZOOM 3 | 0.000 | −0.524 |

Table 21 is a table obtained by summarizing values at Position 1 and Position 2 for Zoom 1 to Zoom 3. The value at Position 2 for Zoom 1 illustrated in Table 21 is the shortest shooting distance. In the case of Example 4, the shortest shooting distance is 300 mm.

TABLE 22

| SURFACE | | | | | | | | |
|---|---|---|---|---|---|---|---|---|
| NUMBER | 3 | 4 | 5 | 6 | 7 | 8 | 10 | 11 |
| K | 0 | 0 | 1.629650 | 20.662944 | −87.902200 | 7.889563 | −29.062154 | 99.000000 |
| A4 | 0 | 0 | −3.361748.E−04 | 8.474824.E−03 | 9.273941.E−03 | 4.499710.E−03 | 8.262782.E−03 | 1.270278.E−02 |
| A6 | 0 | 0 | 5.633035.E−05 | −3.404941.E−03 | −4.492315.E−03 | −1.995911.E−03 | −2.167832.E−03 | −2.236828.E−03 |
| A8 | 0 | 0 | −1.706475.E−05 | 8.167255.E−04 | 1.160548.E−03 | 6.571246.E−04 | 6.613391.E−04 | 5.660211.E−04 |
| A10 | 0 | 0 | 2.004424.E−06 | −1.138606.E−04 | −1.731048.E−04 | −1.137201.E−04 | −1.606008.E−04 | −1.479196.E−04 |
| A12 | 0 | 0 | −1.453133.E−07 | 9.855519.E−06 | 1.595318.E−05 | 1.151061.E−05 | 2.546489.E−05 | 2.656869.E−05 |
| A14 | 0 | 0 | 5.770128.E−09 | −5.400688.E−07 | −9.224533.E−07 | −6.822607.E−07 | −2.516031.E−06 | −2.962793.E−06 |
| A16 | 0 | 0 | −1.146294.E−10 | 1.845856.E−08 | 3.279864.E−08 | 2.294738.E−08 | 1.490246.E−07 | 2.001987.E−07 |
| A18 | 0 | 0 | −7.273163E−12 | −3.545625E−10 | −6.490121E−10 | 9.041865E−11 | −4.995132.E−09 | −8.734634.E−09 |
| A20 | 0 | 0 | 4.855034E−13 | 2.640772E−12 | 4.800011E−12 | −4.480689E−11 | 8.305392.E−11 | 2.524907.E−10 |

TABLE 23

| PARAMETER | INF | UNIT |
|---|---|---|
| LTL | 26.210 | mm |
| da | 7.800 | mm |
| L | 5.387 | mm |
| EPD | 5.625 | mm |
| DFOV | 24.077 | deg |
| dd | 5.120 | mm |
| EPT | −17.009 | mm |
| EFL | 23.561 | mm |
| FNO | 3.021 | |
| f_B2 | −6.206 | mm |
| f_F | 6.762 | mm |
| f_B2/f_F | −0.918 | |
| EFL/dd | 4.602 | |
| EPT/PL | −0.895 | |
| EPD/Pref_d | 1.776 | |
| EFL1/EFL | 0.836 | |
| f_B/EFL1 | −2.04 | |
| 1/EFL1 | 0.0508 | |

TABLE 24
REFLECTIVE LIGHT GUIDE ELEMENT

| PARAMETER | INF | UNIT |
|---|---|---|
| Pref_d | 3.167 | mm |
| P_t | 5.000 | mm |
| θ | 30.0 | deg |
| P_od | 10.970 | mm |
| PL: PRISM OPTICAL | 19.000 | mm |
| LENGTH | | |

The imaging lens 6 according to Example 4 inner-focuses the LA having a configuration of a 1/1.56 inch-size sensor, a telephoto lens with a 35 mm equivalent focal length of 100 mm, F-number 3.0, and three reflections in the reflective light guide element 35. Also in this configuration, the defocus due to temperature does not nearly occur. Moreover, it turns out that each aberration is properly adjusted from FIGS. 18A, 18B, 18C, and 18D.

Therefore, it can be said that Example 4 is one of the optical settings effective for suppressing the defocus due to temperature in the inner focus lens configuration.

### Second Modification Example of First Embodiment

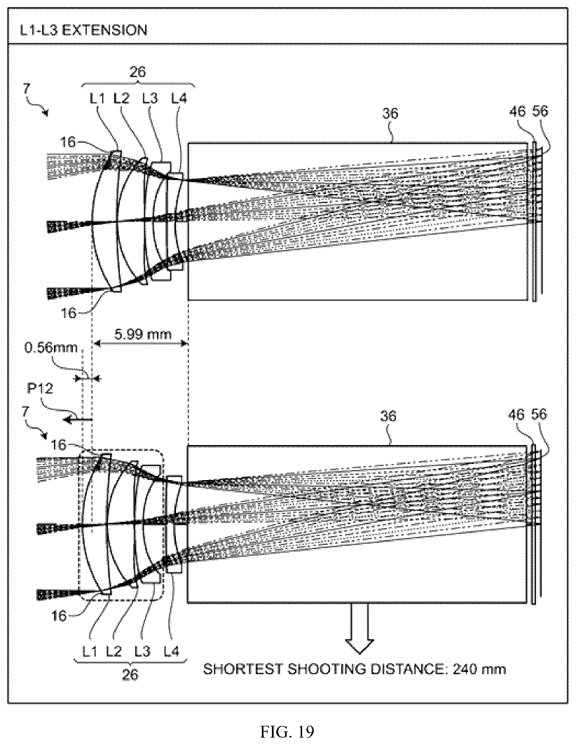

Herein, the brief description for another inner focus method that is one of modification examples of the first embodiment is performed by using a simplified imaging lens 7 illustrated in FIG. 19. Note that the explanation common with the imaging lens according to the first embodiment is omitted as appropriate, and points different from the imaging lens according to the first embodiment will be described.

FIG. 19 is an explanatory diagram illustrating the imaging lens 7 according to the second modification example of the first embodiment. The imaging lens 7 illustrated in FIG. 19 includes a diaphragm 16, a lens group 26, and a reflective light guide element 36. The light from the object side passes through the diaphragm 16, the lens group 26, and the reflective light guide element 36 in this order, and is emitted to an imaging element 56 via an IR filter 46. The imaging lens 7 illustrated in FIG. 19 is an imaging lens that employs a focus method of extending toward the object side one group of lenses, which are some lenses of the lens group 26, from the first lens to plural lenses in the passage order of light from the object side.

The reflective light guide element 36 is similar to the configuration of the reflective light guide element 30 with the odd number of reflections illustrated in FIG. 4. FIG. 19 illustrates the reflective light guide element 36 in a simplified form similar to the form illustrated in FIG. 16.

In the configuration of the imaging lens 7 illustrated in FIG. 19, one group of lenses from the first lens L1 to the third lens L3 among the four lenses of the four-piece configuration as an example is driven. The one group of lenses from the first lens L1 to the third lens L3 illustrated in FIG. 19 is extended by the VCM drive in a lens optical axis direction P12 that is the object side. In this configuration, when the movement distance of the one group of lenses from the first lens L1 to the third lens L3 illustrated in FIG. 19 is 0.56 mm, the shortest shooting distance is 240 mm.

When employing the method of extending the one group of lenses like the second modification example of the first embodiment, it can be considerably shortened because the shortest shooting distance is 240 mm in one example. Note that three lenses of the first lens L1 to the third lens L3 have been explained as one group of lenses but the lens number of one group is not limited to three.

In the case of the focus method according to the second modification example, the lens focuses on the object closer when shooting is performed on the telephoto side by the telephoto lens like the present suggestion. Because a depth of field is shallow, the lens focuses on the object and the background can be taken more blurred.

### Example According to Second Modification Example: Example 5

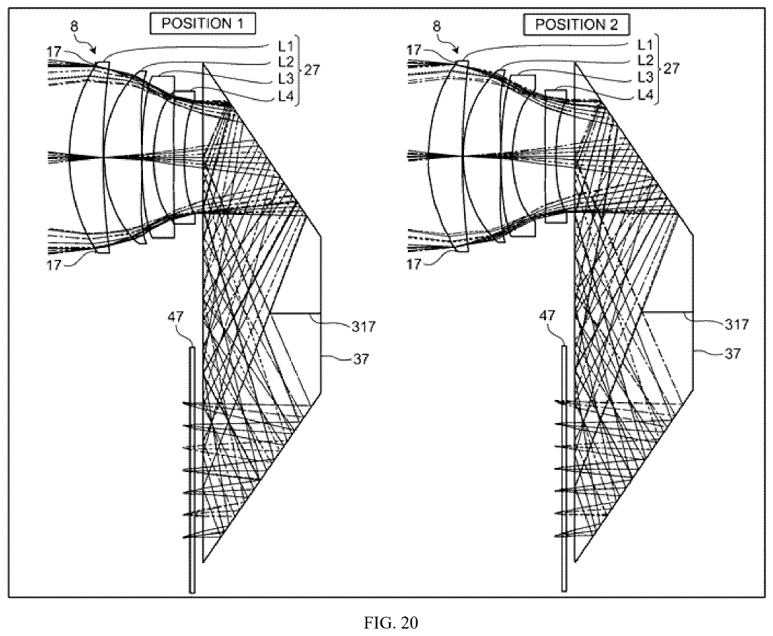

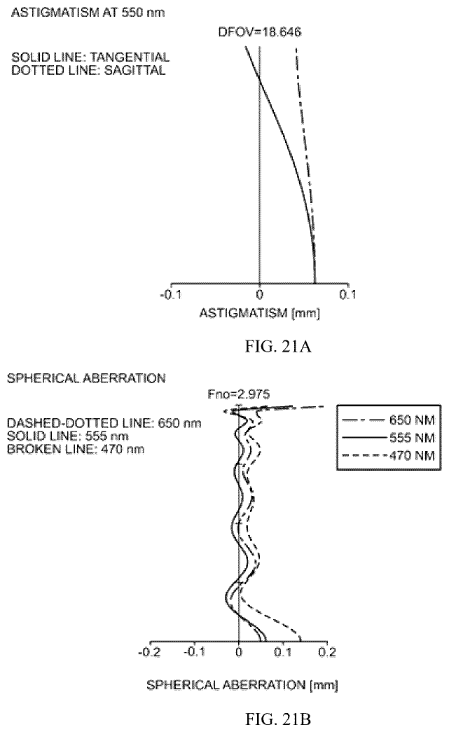

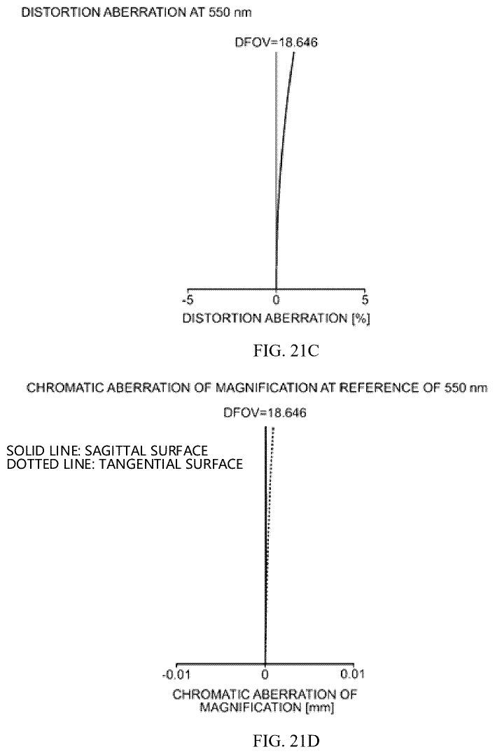

FIG. 20 is a diagram illustrating an example of a configuration of an imaging lens 8 according to Example 5. The imaging lens 8 illustrated in FIG. 20 includes a diaphragm 17, a lens group 27, and a reflective light guide element 37. Moreover, the reflective light guide element 37 includes a ray cut part 317. The light from the object side passes through the diaphragm 17, the lens group 27, and the reflective light guide element 37 in this order, and is emitted toward an IR filter 47. FIGS. 21A, 21B, 21C, and 21D are aberration diagrams of the imaging lens 8 according to Example 5.

As illustrated in FIG. 20, the first lens L1 to the third lens L3 take two positions by the focus. The optical settings of the imaging lens 8 according to Example 5 are illustrated by Table 25 to Table 29.

TABLE 25

| SURFACE | | | | | GLASS | | | | | | |
|---|---|---|---|---|---|---|---|---|---|---|---|
| NUMBER | R | D | Nd | Vd | MATERIAL | FOCAL LENGTH | | | | | |
| 0 | INF | ZOOM 1 | | | | | | | | | |
| 1 | INF | 1.200 | | | | | | | | | |
| STO | INF | −1.200 | | | | | | | | | |
| 3 | 7.922 | 1.518 | 1.552 | 70.70 | GLASS | 18.830 | | 6.934 | 24.781 | f_F | |
| 4 | 31.188 | 0.050 | | | | | | | | | |
| 5 | 6.384 | 1.680 | 1.544 | 56.33 | PLASTIC | 10.101 | −32.626 | | | | f_B |
| 6 | −35.536 | 0.050 | | | | | | | | | |
| 7 | 62.637 | 0.500 | 1.593 | 28.27 | PLASTIC | −12.913 | | −6.311 | | f_B2 | |
| 8 | 6.730 | 0.872 | | | | | | | | | |
| 9 | INF | ZOOM 2 | | | | | | | | | |
| 10 | −21.999 | 0.500 | 1.544 | 56.33 | PLASTIC | −13.344 | | | | | |
| 11 | 10.9045 | 0.820 | | | | | | | | | |
| 12 | INF | 21.097 | 1.517 | 64.17 | GLASS | | | | | | |
| 13 | INF | 0.345 | | | | | | | | | |
| 14 | INF | 0.210 | 1.517 | 64.17 | GLASS | | | | | | |
| 15 | INF | 0.350 | | | | | | | | | |
| 16 | INF | 0.000 | | | | | | | | | |

Table 25 includes Zoom 1 and Zoom 2. Zoom 1 indicates a distance from the vertex of the first lens L1 to the object. Zoom 2 indicates an interval from the third lens L3 to the fourth lens LA.

Zoom 1 is INF (infinity) at Position 1, but is the shortest shooting distance at Position 2.

TABLE 26

| | POSITION 1 | POSITION 2 |
|---|---|---|
| ZOOM 1 | INF | 235 |
| ZOOM 2 | 0.000 | 0.571 |

Table 26 is a table obtained by summarizing values at Position 1 and Position 2 for Zoom 1 and Zoom 2. The value at Position 2 for Zoom 1 illustrated in Table 26 is the shortest shooting distance. In Example 5 of the second modification example, it turned out that the shortest shooting distance is 235 mm and the shortest shooting distance can be made closer.

TABLE 27

| SURFACE | | | | | | | | |
|---|---|---|---|---|---|---|---|---|
| NUMBER | 3 | 4 | 5 | 6 | 7 | 8 | 10 | 11 |
| K | 0 | 0 | 1.546705 | 26.673906 | 21.275698 | 1.339360 | 30.035528 | 11.918727 |
| A4 | 0 | 0 | 6.011021.E−05 | 1.815675.E−02 | 1.724515.E−02 | 1.907226.E−03 | 1.070151.E−02 | 8.891786.E−03 |
| A6 | 0 | 0 | −1.280469.E−04 | −1.274048.E−02 | −1.461636.E−02 | −3.027088.E−03 | −4.512150.E−03 | −3.253149.E−03 |
| A8 | 0 | 0 | 4.485568.E−05 | 5.027891.E−03 | 6.219199.E−03 | 1.440618.E−03 | 2.125328.E−03 | 1.335329.E−03 |
| A10 | 0 | 0 | −1.561646.E−05 | −1.164554.E−03 | −1.497661.E−03 | −2.342884.E−04 | −7.292845.E−04 | −4.760479.E−04 |
| A12 | 0 | 0 | 3.291834.E−06 | 1.673033.E−04 | 2.197661.E−04 | −1.311226.E−05 | 1.662836.E−04 | 1.172800.E−04 |
| A14 | 0 | 0 | −4.145821.E−07 | −1.519445.E−05 | −2.010135.E−05 | 1.063699.E−05 | −2.458000.E−05 | −1.895981.E−05 |
| A16 | 0 | 0 | 3.002632.E−08 | 8.531214.E−07 | 1.121833.E−06 | −1.627782.E−06 | 2.264470.E−06 | 1.903483.E−06 |
| A18 | 0 | 0 | −1.160356E−09 | −2.714259E−08 | −3.501591E−08 | 1.110558E−07 | −1.181960.E−07 | −1.073522.E−07 |
| A20 | 0 | 0 | 1.838745E−11 | 3.756528E−10 | 4.693328E−10 | −2.945076E−09 | 2.670159.E−09 | 2.577080.E−09 |

TABLE 28

| PARAMETER | INF | UNIT |
|---|---|---|
| LTL | 27.992 | mm |
| da | 8.320 | mm |
| L | 5.170 | mm |
| EPD | 5.948 | mm |
| DFOV | 18.646 | deg |
| dd | 4.096 | mm |
| EPT | −17.516 | mm |
| EFL | 24.781 | mm |
| FNO | 2.978 | |
| f_B2 | −6.311 | mm |
| f_F | 6.934 | mm |
| f_B2/f_F | −0.910 | |
| EFL/dd | 6.050 | |
| EPT/PL | −0.830 | |
| EPD/Pref_d | 2.069 | |
| EFL1/EFL | 0.760 | |
| f_B/EFL1 | −1.73 | |
| 1/EFL1 | 0.0531 | |

TABLE 29
REFLECTIVE LIGHT GUIDE ELEMENT

| PARAMETER | INF | UNIT |
|---|---|---|
| Pref_d | 2.875 | mm |
| P_t | 5.000 | mm |
| θ | 34.0 | deg |
| P_od | 14.230 | mm |
| PL: PRISM OPTICAL | 21.097 | mm |
| LENGTH | | |

The imaging lens 8 according to Example 5 focuses the L1 to L3 having a configuration of a 1/2.0 inch-size sensor, a telephoto lens with a 35 mm equivalent focal length of 131 mm, F-number 3.0, and three reflections in the reflective light guide element 37. Even in this configuration, the defocus due to temperature does not nearly occur. Moreover, it turns out that each aberration is properly adjusted from FIGS. 21A, 21B, 21C, and 21D.

Therefore, it can be said that Example 5 is one of the optical settings effective for suppressing the defocus due to temperature in the method of focusing some lens group like the L1 to L3 focus.

### Second Embodiment

Next, a configuration of an imaging device according to a second embodiment will be described. Note that the imaging device is described below as a smartphone as an example but the imaging device is not limited to the smartphone. If it is an imaging device, the imaging device can be also applied to another form, that is, a tablet terminal, for example.

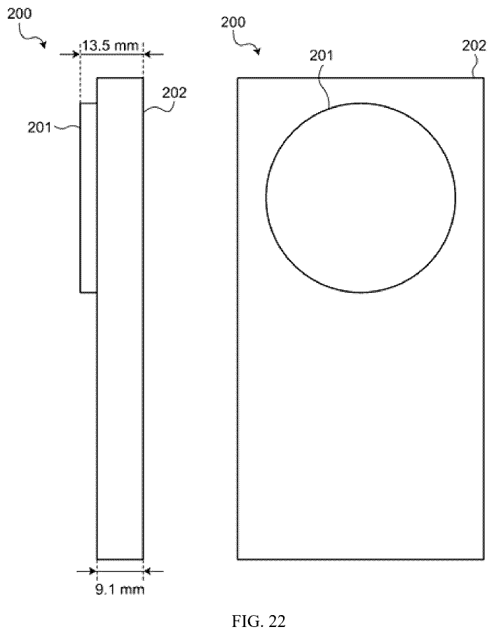

FIG. 22 is a diagram illustrating an example of the configuration of the imaging device according to the second embodiment. FIG. 22 illustrates an example of an exterior configuration of a smartphone 200 that is the imaging device according to the second embodiment.

A right side view and a front view of the smartphone are illustrated in FIG. 22. The smartphone 200 includes a camera part 201 and a thin body 202. The camera part 201 is mounted with a plurality of cameras. The smartphone 200 illustrated as an example has a thinned design in which the camera part 201 has the thickness of 13.5 mm and the body 202 has the thickness of 9.1 mm as illustrated in the right side view.

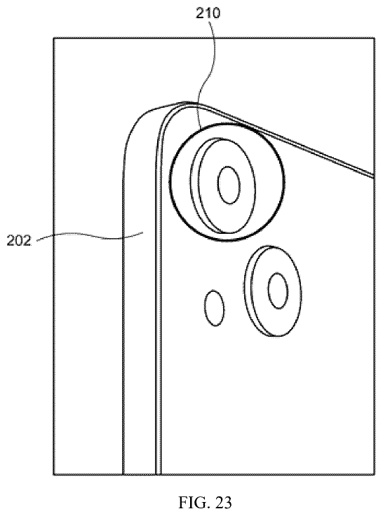

FIG. 23 is a diagram illustrating an example of a configuration of a camera of the camera part 201. The camera part 201 illustrated in FIG. 23 as an example is mounted with two cameras including a wide-angle camera, a telephoto camera, etc. A lens housing 210 of the telephoto camera among lens housings of the two cameras is a lens housing of the imaging lens with temperature compensation.

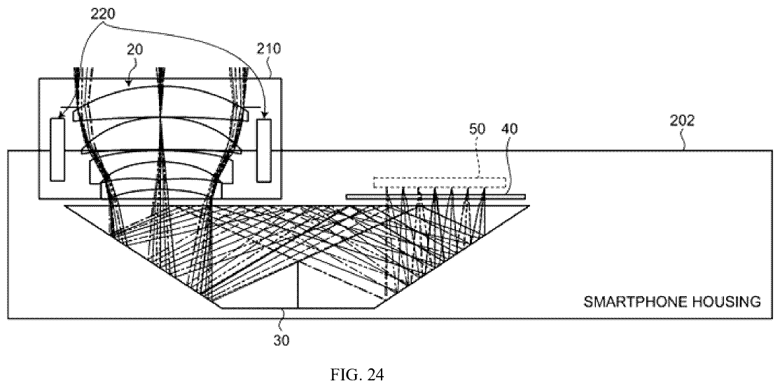

FIG. 24 is a diagram illustrating a mounting example of the imaging lens 1 with temperature compensation illustrated in FIG. 4. FIG. 24 illustrates the configuration of the imaging lens 1 in the thickness direction of the smartphone 200. The lens group 20 of the imaging lens 1 with temperature compensation is housed in the lens housing 210. The lens housing 210 has cover glass on the vertex side of the first lens.

Moreover, a VCM 220 is arranged in the lens housing 210 near the lens group 20. The VCM 220 is VCM equivalent to the VCM of the wide-angle camera, and can move the lenses of the lens group 20 to the object side about 0.6 mm. In other words, the lenses of the lens group 20 can be moved to the object side about 0.6 mm at maximum in the lens housing 210.

A part of the lens housing 210 is housed in the body 202. Depending on a depth of the housing part, a space is formed between the object-side surface (front side) of the body 202 and the reflective light guide element 30 in the thickness direction of the body 202. The IR filter 40 and the imaging element 50 are arranged in the space.

The overall thickness of the camera part 201 can be thinned by such the arrangement. Moreover, the thickness of the body 202 can be also thinned by the configuration of the reflective light guide element 30 with multiple reflections. The reflective light guide element 30 illustrated in FIG. 24 has the configuration of three reflections, but the thickness of the body 202 can be thinned more by increasing the number of reflections of the odd number of reflections.

Therefore, even if the camera is a telephoto camera such as the telephoto with a 35 mm equivalent focal length of 135 mm, the smartphone 200 with the thinned design can be realized. Moreover, the shortest shooting distance can be shortened more due to the temperature compensation.

Note that the shape of the reflective light guide element 30 illustrated in the first embodiment, the second embodiment, or the like is only an example. For example, the incident surface 301 and the exit surface 302 of the reflective light guide element 30 are set as a plane, but these surfaces are not limited to a plane. One or both of the incident surface 301 and the exit surface 302 may be set as a shape other than a plane. For example, these may be set as a slope surface or another shape. In that case, the IR filter 40 and the imaging element 50 are arranged in accordance with the direction of the rays emitted from the exit surface.

Moreover, the number of reflections of the reflective light guide element 30 is an example, and the number is not limited to this. The number of reflections may be an even number. In the case of the even number of reflections, the IR filter 40 and the imaging element 50 may be moved and arranged from the front-side position to the rear-side position of the reflective light guide element 30.

Comparison of Effect with Periscope Type

Next, a difference in effect between the periscope smartphone and the smartphone 200 illustrated in FIGS. 22, 23, and 24 will be described.

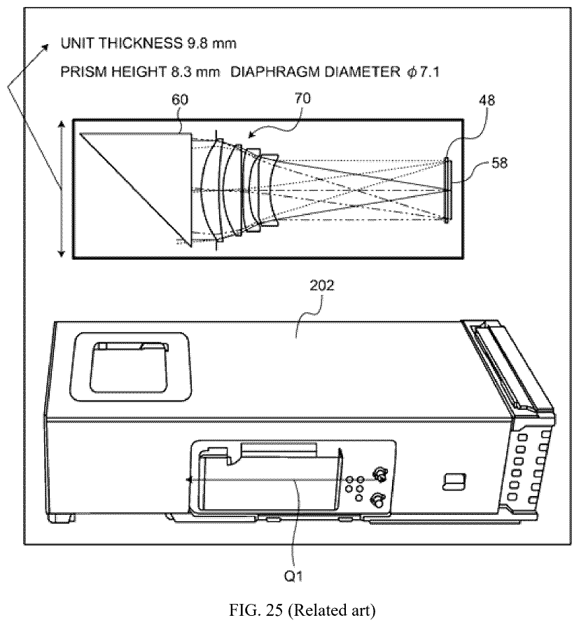

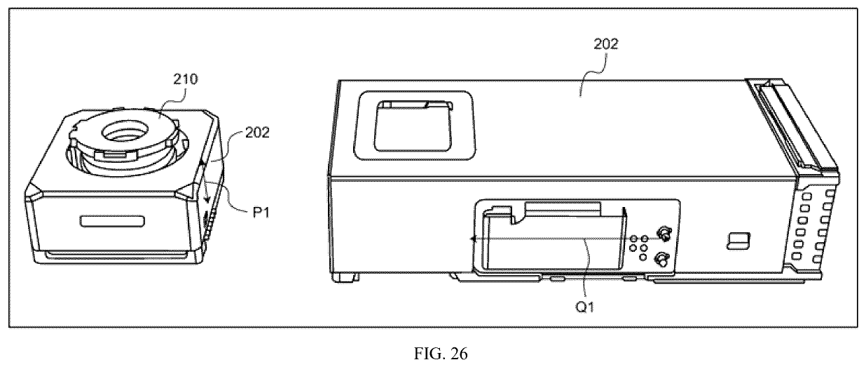

FIG. 25 is a diagram illustrating an example of a configuration of a smartphone mounted with a periscope lens. FIG. 26 is a diagram explaining a difference in thickness between the periscope smartphone and the smartphone 200 illustrated in FIGS. 22, 23, and 24.

FIG. 25 illustrates a configuration of a periscope lens unit and an appearance of the smartphone mounted with the periscope lens unit. The periscope lens unit includes a single reflection prism 60 and a lens group 70. The periscope lens unit is arranged in the smartphone in a direction in which the optical axis of the lens group 70 is a direction orthogonal to the thickness direction of the smartphone. In other words, in the case of the periscope type, the height of the prism, the lens diameter of the lens unit, etc. affect the thickness of the smartphone.

For example, in the case of the normal periscope type of a tele lens of an image height 4 mm (½ inch) sensor, a focal length 24.78 mm, and a 35 mm equivalent focal length of 131 mm of F-number 3.5, the diaphragm diameter is φ7.1. Because the height of the prism is about 8.3 mm and the thickness of the lens unit is about 9.8 mm, it cannot be housed in the body 202 of the thin smartphone with the thickness of 9.1 mm. Alternatively, an area of an electrical board mounted in the smartphone becomes great, and thus the size of the smartphone increases greatly.

In the smartphone mounted with the periscope lens unit of FIG. 25, the lenses of the lens unit are moved to the direction of an arrow Q1. For this reason, the smartphone mounted with the periscope lens unit has the advantage that a plurality of VCMs can be arranged in the direction of the arrow Q1.

On the other hand, in the smartphone 200 as illustrated in FIG. 26, the lenses of the lens group 20 are moved inside the lens housing 210 to the arrow P1 direction of the thickness direction of the body 202. Thus, if it is the imaging device of the present suggestion like the smartphone 200, the shortest shooting distance can be shortened without arranging the plurality of VCMs, and the thickness of the body can be reduced compared with the smartphone mounted with the periscope lens unit.

Moreover, when making the body thin, the imaging device of the present suggestion is advantageous when the number of installations of VCMs for driving the lenses in the thickness direction of the body has a limitation.

Moreover, a numerical value of the shortest shooting distance, numerical values of dimension of the smartphone, numerical values of various settings, and the like described herein are indicated as an example for comparison with the conventional, and numerical values are not limited to these values. The numerical values may be changed as appropriate without departing from the spirit of the inventions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### EXPLANATIONS OF LETTERS OR NUMERALS

1, 2, 3, 4, 5, 6, 7, 8: Imaging lens
10, 11, 12, 13, 14, 15, 16, 17: Diaphragm
20, 21, 22, 23, 24, 25, 26, 27: Lens group
30, 31, 32, 33, 34, 35, 36, 37: Reflective light guide element
40, 41, 42, 43, 44, 45, 46, 47: IR filter
50, 54, 56: Imaging element
200: Smartphone
201: Camera part
202: Body
210: Lens housing
301: Incident surface
302: Exit surface
303: First slope
304: First plane
305: Second slope
310, 313, 315, 317: Ray cut part
L1: First lens
L2: Second lens
L3: Third lens
L4: Fourth lens

1. An imaging lens comprising:
in order of passage of light from an object side,
a diaphragm;
a lens group including at least one lens having positive optical power and at least one lens having negative optical power; and
a reflective light guide element configured to emit light toward an imaging element;
wherein the one lens having positive optical power is made of glass material; and
wherein the reflective light guide element has reflecting surfaces on which an optical path is reflected multiple times.

2. The imaging lens according to claim 1, wherein in the lens group, a first lens through which the light from the object side passes first is a lens having positive optical power, and a final lens through which the light from the object side passes finally is a lens having negative optical power.

3. The imaging lens according to claim 1, wherein the reflective light guide element has the reflecting surfaces on which the optical path is reflected by an odd number of reflections.

4. The imaging lens according to claim 1, wherein the imaging lens has a focus method of driving at least one lens in the lens group.

5. The imaging lens according to claim 4, wherein the focus method includes an inner focus method of driving a lens in the lens group through which the light from the object side passes finally.

6. The imaging lens according to claim 4, wherein the focus method includes a focus method of extending toward the object side one group of lenses, which are some lenses of the lens group, from a first lens to plural lenses in the order of passage of the light from the object side.

7. The imaging lens according to claim 1, wherein the reflective light guide element includes, as a ray cut part configured to reduce or cut some rays, at least one of:
a low-reflection black absorber provided on a portion of a surface of the reflective light guide element;
a light shielding part provided inside the reflective light guide element; and
a void part provided from the surface to an inside of the reflective light guide element.

8. The imaging lens according to claim 1, wherein the reflecting surfaces are provided by reflective material on the reflective light guide element.

9. The imaging lens according to claim 1, wherein each of the reflecting surfaces of the reflective light guide element has a dichroic mirror that changes a reflectance in response to an incident angle of the light.

10. The imaging lens according to claim 1, wherein “1/a focal length of a glass material lens<0.06” is satisfied.

11. The imaging lens according to claim 1, wherein “0.7<a focal length of a glass material lens/EFL<1.0”, in which “EFL” is a focal length of an entire lens, is satisfied.

12. The imaging lens according to claim 1, wherein “−1.0<EPT/PL<−0.7”, in which “EPT” is an exit pupil distance and “PL” is an optical length of the optical path by which lens optical axis rays pass through the reflective light guide element, is satisfied.

13. The imaging lens according to claim 1, wherein “3<EFL/dd”, in which “EFL” is a focal length of an entire lens and “dd” is a half size of a sensor surface of the imaging element in a diagonal direction, is satisfied.

14. The imaging lens according to claim 1, wherein “EPD/Pref_d<3.5”, in which “EPD” is an exit pupil diameter and “Pref_d” is a distance from an incident surface of the reflective light guide element to an intersection point at which a lens optical axis and a first reflecting surface intersect with each other, is satisfied.

15. The imaging lens according to claim 1, wherein “f_F>0”, in which “f_F” is a focal length of remaining lenses other than a final lens and a lens just before the final lens in the order of passage of the light from the object side among lenses included in the lens group, is satisfied.

16. The imaging lens according to claim 1, wherein “f_B2<0”, in which “f_B2” is a focal length of two lenses that are a final lens and a lens just before the final lens in the order of passage of the light from the object side among lenses included in the lens group, is satisfied.

17. The imaging lens according to claim 1, wherein “−1.5<f_B2/f_F<−0.5”, in which “f_B2” is a focal length of two lenses that are a final lens and a lens just before the final lens in the order of passage of the light from the object side among lenses included in the lens group and “f_F” is a focal length of remaining lenses other than the final lens and the lens just before the final lens in the order of passage of the light from the object side among the lenses included in the lens group, is satisfied.

18. The imaging lens according to claim 1, wherein “L>P_t”, in which “L” is a distance from a lens vertex of a lens through which the light from the object side passes first to the reflective light guide element and “P_t” is a thickness of the reflective light guide element in a lens optical axis direction, is satisfied.

19. The imaging lens according to claim 1, wherein “−10<f_B/a focal length of a glass material lens<−1”, in which “f_B” is a focal length of a plastic lens, is satisfied.

20. An imaging device comprising:
an imaging lens, comprising:
in order of passage of light from an object side:
a diaphragm;
a lens group including at least one lens having positive optical power and at least one lens having negative optical power; and
a reflective light guide element configured to emit light toward an imaging element;
wherein the one lens having positive optical power is made of glass material; and
wherein the reflective light guide element has reflecting surfaces on which an optical path is reflected multiple times; and
an imaging element configured to capture an image of an object via the imaging lens.
